(19) United States
(12) Patent Application Publication
(10) Pub. No.: US 2009/0300525 A1
(43) Pub. Date: Dec. 3, 2009

(54) METHOD AND SYSTEM FOR AUTOMATICALLY UPDATING AVATAR TO INDICATE USER'S STATUS

(76) Inventors: Maria Elena Romera JOLLIFF, Vista, CA (US); Samuel Jacob HORODEZKY, San Diego, CA (US); Tia CHUNG, San Diego, CA (US); Kameron KERGER, San Diego, CA (US); Gregory James BROWN, Poway, CA (US); Todd Jeffrey JOHNSGARD, Alpine, CA (US); Joseph Jyh-Huei HUANG, San Diego, CA (US); Ankur JALOTA, San Diego, CA (US); Devender YAMAKAWA, San Diego, CA (US); Jadine Naomi YEE, San Diego, CA (US); Scott Alan LEAZENBY, San Diego, CA (US); Chad Andrew WILLKIE, San Diego, CA (US)

Correspondence Address: QUALCOMM INCORPORATED, 5775 MOREHOUSE DR., SAN DIEGO, CA, 92121, US

(21) Appl. No.: 12/127,349

(22) Filed: May 27, 2008

(51) Int. Cl. G06F 3/048

(52) U.S. Cl. 715/764

(57) ABSTRACT

A cellular or wireless mobile device includes a one or more sensors and a processor configured with software to receive data from the one or more sensors, calendar data and device settings, compare sensor, calendar, device settings data, and an authorization level of a requesting user to avatar selection criteria, and select an avatar based upon the comparison. By correlating sensor data, calendar data and device settings to a user's current status, the avatar selection criteria enables a processor to automatically select an avatar that reflects the user's current status. Others then can be informed of the user's current status by accessing the user's avatar.

### FIELD OF THE INVENTION

The present invention relates generally to providing a current indication of a user's status or activity via a computer generated avatar.

### BACKGROUND

In the computing sense, an avatar is a virtual representation of a computer user. The term “avatar” can also refer to the personality connected with a screen name, or handle, of an Internet user. Avatars are often used to represent the real world user in the virtual world of computing. Avatars can be three-dimensional models used in virtual reality applications and computer games. Avatars can also be a two-dimensional icon (picture) used in Internet forums and other online communities, instant messaging, gaming and non-gaming applications. Avatars may be animated or static.

The term avatar dates at least as far back as 1985, when it was used as the name for the player character in a series of computer games. Recently, the usage of avatars has spread in popularity and avatars are now often used in Internet forums. Avatars on Internet forums serve the purpose of representing users and their actions, personalizing their contributions to the forum, and may represent different parts of their persona, beliefs, interests or social status in the forum.

The traditional avatar system used on most Internet forums is a small (96×96 to 100×100 pixels, for example) square-shaped area close to the user's forum post, where the avatar is placed. Some forums allow the user to upload an avatar image that may have been designed by the user or acquired from elsewhere. Other forums allow the user to select an avatar from a preset list or use an auto-discovery algorithm to extract one from the user's homepage.

In the instant messaging (IM) context, avatars, sometimes referred to as buddy icons, are usually small images. For example, IM icons are 48×48 pixels, although many icons can be found online that typically measure anywhere from 50×50 pixels to 100×100 pixels in size. A wide variety of these imaged avatars can be found on web sites and popular eGroups such as Yahoo! Groups. The latest use of avatars in instant messaging is dominated by dynamic avatars. The user chooses an avatar that represents him while chatting and, through the use of text to speech technology, enables the avatar to talk the text being used at the chat window. Another form of use for this kind of avatar is for video chats/calls. Some services, such as Skype (through some external plug-ins) allow users to use talking avatars during video calls, replacing the image from the user's camera with an animated, talking avatar.

### SUMMARY

Various embodiment systems and methods are disclosed which automatically update a user's virtual world avatar to provide a more accurate representation of the user's current real world status or activity. Embodiments may receive information from a variety of sensors located either within the user's mobile device or within close proximity to the mobile device to provide some parameters of the user's real world environment. The variety of sensors may include, but are not limited to a location sensor (e.g., GPS coordinates), a microphone for sensing ambient noise, a camera or light sensor for sensing ambient light, accelerometers, temperature sensor, and bio-physiological sensors such as a breathalyzer, heart rate monitor, pulse sensor, EEG, ECG, EKG, and/or blood pressure sensor. In addition, embodiments may utilize a user's calendar data as well as mobile device settings to generate an updated virtual representation via an avatar of the user's real world status or activity. Alternative embodiments may age the user's avatar over time so that a user's avatar grows older, more mature as the user grows older, more mature. Various embodiments automatically update or change the user's avatar as the user goes about his/her daily activities. Other embodiments update or change the user's avatar when a request to view the avatar is made. The user's avatar may be viewed in a singular location, such as a webpage. Alternative embodiments may allow a user's avatar to be downloaded to any requesting party. Still other embodiments may pro-actively inform selected parties of a user's current real world status or activity by sending an avatar.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 illustrates exemplary avatars suitable for use with the various embodiments.

FIG. 2 is system block diagram of a system suitable for use with the various embodiments.

FIG. 3 is a system block diagram of a mobile device suitable for use with the various embodiments.

FIG. 4 is a process flow diagram of an embodiment method suitable for implementation on the system.

FIG. 5 is a process flow diagram of a specific embodiment method suitable for implementation on a mobile handset.

FIG. 6a is an example parameter data table suitable for storing a variety of sensor data, user calendar data, and mobile device settings indicating the current status of the user.

FIG. 6b is an illustrative avatar selection logic table which indicates an avatar to display based on various parameters.

FIG. 6c is a process flow diagram of an embodiment method for calibrating an avatar selection logic table.

FIG. 7 is a process flow diagram of an embodiment method suitable for implementation on a mobile handset which conserves battery and processor time.

FIG. 8 is a process flow diagram of an embodiment method suitable for implementation on a mobile handset which responds to a server request.

FIG. 9 is a process flow diagram of an embodiment method suitable for implementation on a mobile handset which responds to a second user request.

FIG. 10 is a process flow diagram of another embodiment method wherein avatar selection is offloaded to a server.

FIG. 11 is a process flow diagram of another embodiment method wherein avatar selection is offloaded to a server which conserves battery and processor time.

FIG. 12 is a process flow diagram of another embodiment method wherein avatar selection is offloaded to a server which conserves battery and processor time by responding to a server request.

FIG. 13 is a process flow diagram of another embodiment method wherein avatar selection is offloaded to a server which conserves battery and processor time by responding to a second user request.

FIG. 14a is a process flow diagram of another embodiment method suitable for displaying an avatar directly on the requesting device.

FIG. 14b is a process flow diagram of another embodiment method suitable for displaying a new or updated avatar directly on the requesting device

FIG. 15a is a process flow diagram of another embodiment method suitable for displaying an avatar directly on the requesting device which conserves battery and processor time.

FIG. 15b is a process flow diagram of another embodiment method suitable for displaying a new or updated avatar directly on the requesting device which conserves battery and processor time.

FIG. 16a is a process flow diagram of another embodiment method suitable for displaying an avatar directly on the requesting device which conserves battery and processing time by responding to a second user request.

FIG. 16b is a process flow diagram of another embodiment method suitable for displaying a new or updated avatar directly on the requesting device which conserves battery and processing time by responding to a second user request.

FIG. 17 is a process flow diagram of another embodiment method suitable for displaying an avatar directly on the requesting device wherein avatar selection is offloaded to the requesting user's device.

FIG. 18 is a process flow diagram of an alternative embodiment method suitable for implementation on the system.

FIG. 19a is an example parameter data table suitable for storing a variety of sensor data, user calendar data, mobile device settings and authorization level of a user requesting an avatar.

FIG. 19b is an illustrative avatar selection logic table which indicates an avatar to display based on various parameters including the authorization level of the requesting user.

FIG. 19c is a process flow diagram of an embodiment method for calibrating an avatar selection logic table including the authorization level of the requesting user.

FIG. 20 is a process flow diagram of an embodiment method for selecting an avatar for display based upon an avatar selection logic table including the authorization level of the requesting user.

FIG. 21 is a process flow diagram of another embodiment method for selecting an avatar for display based upon an avatar selection logic table including the authorization level of the requesting user.

FIG. 22 is a process flow diagram of another embodiment method for selecting an avatar for display based upon an avatar selection logic table including the authorization level of the requesting user.

FIG. 23 is a process flow diagram of another embodiment method for selecting an avatar for display based upon an avatar selection logic table including the authorization level of the requesting user.

FIG. 24a is a process flow diagram of another embodiment method suitable for displaying an avatar selected based upon sensor and setting data and the authorization level of a second user directly on the requesting device.

FIG. 24b is a process flow diagram of another embodiment method suitable for displaying a new or updated avatar selected based upon sensor and setting data and the authorization level of a second user directly on the requesting device.

FIG. 25a is a process flow diagram of another embodiment method suitable for displaying an avatar selected based upon sensor and setting data and the authorization level of a second user directly on the requesting device.

FIG. 25b is a process flow diagram of another embodiment method suitable for displaying a new or updated avatar selected based upon sensor and setting data and the authorization level of a second user directly on the requesting device.

FIG. 26 is a process flow diagram of another embodiment method suitable for displaying an avatar directly on the requesting device based upon sensor and settings data and the second user's authorization level.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term mobile device may refer to any one or all of cellular telephones, personal data assistants (PDA's), palm-top computers, laptop computers, wireless electronic mail receivers (e.g., the Blackberry® and Treo® devices), multimedia Internet enabled cellular telephones (e.g., the iPhone® ), and similar personal electronic devices which include a programmable processor and memory. In a preferred embodiment, the mobile device is a cellular handset that can communicate via a cellular telephone network (e.g., a cellphone). However, cellular telephone communication capability is not necessary in all embodiments. Moreover, wireless data communication may be achieved by the mobile device connecting to a wireless data network (e.g., a WiFi network) instead of a cellular telephone network.

As used herein, the term “server” refers to any of a variety of commercially available computer systems configured to operate in a client-server architecture. In particular, the term “server” refers to network servers, particularly Internet accessible servers, which typically include a processor, memory (e.g., hard disk memory), and network interface circuitry configured to connect the server processor to the network, such as the Internet.

As used herein, the term “theme” refers to the collection of user-configurable settings that may be implemented on a mobile handset to personalize the mobile handset to the user's preferences. A theme is defined by the files and settings used for any and all of the wallpaper (i.e., images presented on the mobile handset display), ring tones (i.e., audio files triggered by different events), ring settings (e.g., loud, medium, soft and silent, as well as vibrate mode), button tones (i.e., tones played when buttons are pressed), button functions, display icons, and speed dial settings (i.e., the telephone number associated with each button configured for speed dialing). A theme may also include settings for other user-configurable settings like password protections, keypad locks, carrier selections, etc. Composed of such data, a theme can be stored as a mix of files (e.g., image and audio files), as well as configuration data (e.g., telephone numbers associated with particular speed dial buttons).

With the advent of modern computing and mobile communications, individuals are able to communicate with one another in a variety of ways and at all times. In the past, if an individual wanted to communicate with another, communication could be done through face to face conversations, letters, or the telephone. Today, in addition to these conventional means of communications, individuals may communicate with one another via e-mail, SMS, instant messaging, voice over internet protocol (VoIP) calls, video over internet protocol calls, internet forum chats, and telephone communications via mobile device (handset) calls. With so many different channels of communications, individuals expect to be able to contact others whenever they desire. However, some individuals may desire to not be disturbed. For example, an individual may be conducting an important meeting and does not want his mobile device to ring during the meeting. While he may simply turn off his mobile device (or the ringer) he may also wish to inform any callers of the reason he is temporarily unavailable. With mobile communications so ubiquitous, many users expect to be able to contact their intended call recipient at all times. Thus, when an intended recipient does not answer an email, SMS, phone call, etc., the initiating caller is often left wondering why the intended recipient is not responding.

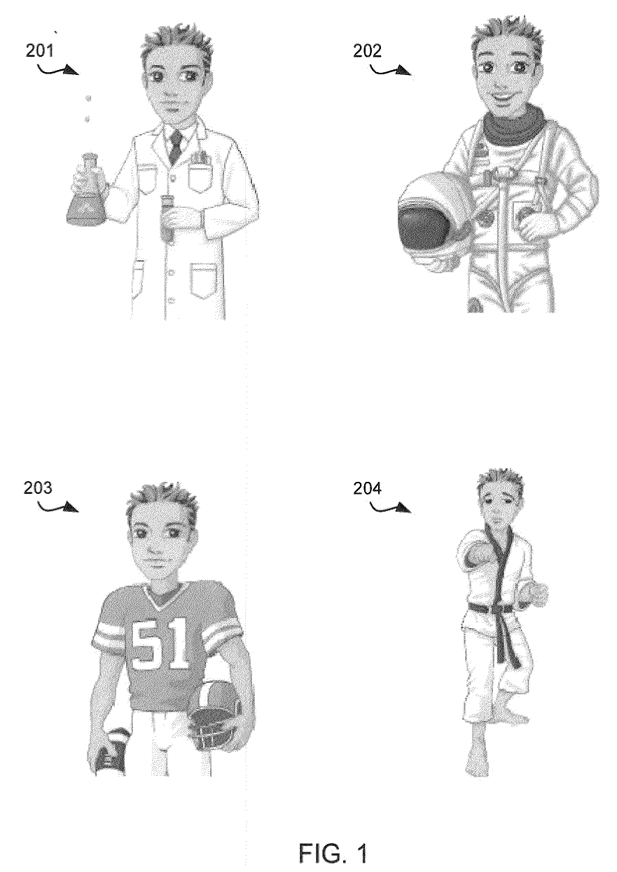

Avatars have gained increasing popularity in use as graphical representations of an individual. An avatar can be text (such as a screen name) or a two or three-dimensional graphical representation (e.g., a photograph, cartoon or machine-generated image). Avatars can be static images or dynamic (animated) images. Examples of some avatars are illustrated in FIG. 1. As shown in FIG. 1, avatars can be images which graphically communicate information about the associated individual, such as professions, hobbies, current activities and moods. Historically, users have used an avatar as a representation of the user or the user's persona in online gaming or internet forum chats. Avatars can efficiently convey information about the user, such as the user's interests, just by nature of the avatar. Conventionally, a user would select an avatar to display a representation of the user participating in an online game, internet forum chat, SMS chat, etc. In this way the selected avatar file may be used to represent the real world user in the virtual world of computing or electronic telecommunications. The various embodiments disclosed herein enable users to generate or post an avatar that more closely represents in a virtual world the real world status of the user.

Mobile devices, particularly cellular telephones, are practically ubiquitous and indispensible. Consequently, mobile devices can be ideal platforms for housing sensors that can measure the environment and activities of user. By properly analyzing motion, sound, location and other sensed information obtained from sensors mounted on user's mobile devices, computer systems can infer user activities, information that can be used in the various embodiments to update users' avatars to reflect their real world activities. For example, a user's mobile device may “learn” that the user's current GPS location is a conference room in the office. Accordingly, the mobile device may automatically set the mobile device to vibrate mode and also automatically update the user's avatar to depict “do not disturb.”

By including the data from a variety of sensors, the various embodiments incorporate or make use of a variety of sensors housed in a user's mobile device, and use the sensor information to update or generate avatars which can be displayed to reflect the user's status, location, mood and/or activity. The various embodiments may employ a variety of sensors and access schedule or calendar information maintained within the mobile device to more accurately reflect the user's status. Such an avatar may be made available for public or private viewing, in order to quickly inform viewers of the user's current status, location, mood and/or activity. Such avatars may be sent to others proactively, such as appended to or included within an SMS or e-mail message, or posted to a server where others can access or download the avatar, such as by accessing an on-line game or website where the avatar is maintained. Avatars may be changed according to users' status on a pre-scheduled basis (e.g., periodic updating), whenever the user's status is requested (e.g., in response to a request for an avatar), or whenever the user's status changes (e.g., when sensors indicate the user's location, mood and/or activity have changed.

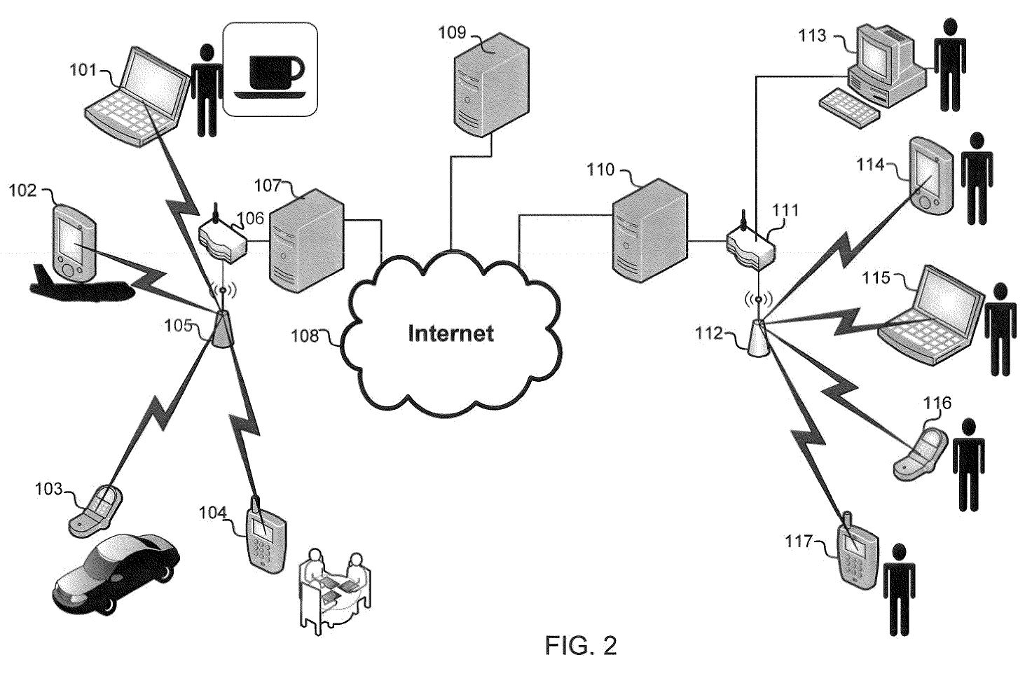

FIG. 2 is a system block diagram of a computing and telecommunications system suitable for use with various embodiments disclosed herein. The system block diagram illustrates an exemplary cellular network system, but is not intended to contemplate all possible configurations. As shown in FIG. 2, a variety of users, engaged in a variety of activities may have on their person a variety of mobile devices. For example, a first user may be using a laptop computer 101 in a coffee shop. A second user may be shopping at an airport carrying a PDA 102. A third user may be driving a car with a cell phone 103. A fourth user may be conducting a meeting and carrying a cell phone 104. Each of the mobile devices 101, 102, 103, and 104 may communicate via wireless networks with wireless communication base stations 105. The wireless communication base stations 105 may be a cell phone tower, Bluetooth receiver, WiFi receiver, or any other wireless transceiver. In a preferred embodiment, the devices communicate via cellular telephone and data networks with a cellular base station antenna 105. The wireless communication base stations 105 may be coupled to a router 106 and wireless communication server 107 to connect to the Internet 108. Alternative paths to the Internet 108 may involve more or less communication equipment. For example, some wireless service providers may require additional servers to provide their users with access to the Internet 108. Alternatively, the wireless communication base station may permit a more direct link to the Internet 108.

Users of mobile devices may communicate with one another or with any other user connected through the Internet 108. For example, a first user may send an email from his laptop 101 to a user at desktop computer 113, a user of a PDA 114, a user of a laptop computer 115, or other users via their cell phones 116, 117. In such a case the user would send an email from the laptop 101 which would be wirelessly transmitted to the base station 105. The email would be sent via a router 106 to a server 107, across the Internet 108 to a server 110 servicing the intended recipient's computing device to a router 111 where it might be sent via a wired connection to a desktop computer 112 or via a wireless base station 112 to a mobile device 114-117. Similarly, the recipient can reply or initiate communications to the user in the reverse manner.

Mobile device users may be unavailable to respond to incoming messages from time to time and may wish to provide some indication of their current status to explain why they are non-responsive. Alternatively, mobile device users may want to inform others as to their current status so that others can know if they are available to communicate. Further, some users may wish to inform their friends and family of their current status and activities as part of their social networking lifestyle. Such notification of a user's status may be accomplished efficiently using an avatar that can be accessed by or presented to selected individuals.

Such an avatar may be maintained and displayed, for example, on the user's social networking webpage (e.g., myspace.com, facebook.com, etc) or any other webpage maintained on an Internet accessible server. The avatar, along with the contents of the webpage and data contained therein, may be stored in the memory of a server 109. The server 109 is connected to the Internet 108 and may be accessed by devices with Internet 108 capabilities and proper access rights.

In an embodiment, users may access a person's avatar, such as by accessing a webpage to display the current status avatar, prior to communicating (e.g., calling, sending an e-mail or sending an SMS message). In another embodiment, when a user attempts to communicate with a person, the user may be automatically directed to the webpage containing the current status avatar if the person does not respond or if the person has selected a “do not disturb” option. In another embodiment, an avatar file may be automatically and directly sent back to a user's device 113-117 for display. In another embodiment, avatar files may be proactively sent to a pre-approved list of recipients whenever a user's status changes, or on regularly scheduled or predetermined intervals. In another embodiment, a link to a user's webpage including an avatar may be sent to a pre-approved list of recipients whenever a user's status changes, or on regularly scheduled or predetermined intervals. As one of skill in the art would appreciate, server 109 may not be necessary if avatar files are being sent directly to a user's device 113-117. In addition, avatars may be hosted on a variety of servers 107, 110, and need not be limited to a particular server 109.

In addition to automatically updating avatars based upon sensed and recorded information, an embodiment enables users to override the automatic updating in order to select a particular avatar regardless of the user's current status. Thus, users may elect to have their avatars reflect their current status at some times, while selecting particular avatars at other times. In alternative embodiments, the user may also set permission or authorization levels for avatars to control who may view a particular avatar, at what times, and during what activities. For example, a user may elect to enable the user's supervisor to view a particular avatar only during work hours. Outside work hours the avatar may be hidden, not transmitted, or reflect a general status, such as busy. In such embodiments, users can set the information and avatars that are public. Such embodiments may be used in updating an avatar on a website or in a general broadcast.

Information from sensors within a user's mobile device can be used to determine how an avatar should be updated. Each of the mobile devices 101-104 may include a variety of sensors which can provide information used to determine the respective users' status. Examples of various sensors will be described in more detail below. In addition, the day, time, and mobile device settings may be considered to provide further information regarding the respective users' status. Further, the mobile device's own operating status may provide information on the user's status.

For example, if a user regularly visits a coffee shop and uses the shops' wireless WiFi network this status could be determined based upon (1) the time of day and day of the week (TOD/DOW), particularly if the breaks are regular or scheduled, (2) activation of the WiFi transceiver, perhaps in combination with TOD/DOW information, (3) GPS (or other location sensor) coordinates, perhaps in combination with TOD/DOW information and activation of the WiFi transceiver, (4) background noise picked up by the device's microphone (e.g., the unique sound of an espresso machine), perhaps in combination with TOD/DOW information, activation of the WiFi transceiver, and GPS coordinate information. Other sensors may also confirm the user's status is consistent with a coffee break, including accelerometers (indicating little if any motion) and temperature (indicating an ambient temperature consistent with an indoor location). If the user skipped his/her coffee break, was home sick or on vacation, an avatar display based solely on TOD/DOW information would inaccurately depict the user's current status. By further referencing the mobile device's GPS sensor, the system can determine if the user is within (or close to) the coffee shop location. Using background noise sensing, the system may confirm a coffee break status recognizing espresso machine noise. Having made this determination of the user's current status, a system (whether the user's mobile device 101 or a server 109 receiving information from the device 101) can select or generate an avatar that graphically depicts this status. In addition, if the device's microphone detected a noise level that exceeded a predetermined limit, the avatar could be altered to reflect the user's ambient environment. This may suggest to someone viewing the avatar that a non-verbal means of communication (e.g., text message) may be the best form of communication if someone wanted to contact the user.

As another example, background noise may be monitored (e.g., using the mobile device's microphone) for music and other sounds that may be used to infer the user's mood. For example, if the background noise includes music with added up-tempo beat, an avatar expressing a happy mood may be selected. As this example illustrates, by increasing the number of sensors used and the variety of information considered, a system can better infer the user's current status.

As another example, a user status of flying in an airplane may be determined by comparing TOD/DOW information to the user's Calendar information. If the user is scheduled to be on an airplane flight and there is no contrary information (e.g., an open WiFi connection with the user's mobile device 102), a system (whether the user's mobile device 101 or a server 109 receiving information from the device 101) can select or generate an avatar that graphically depicts this status. If airlines begin allowing mobile devices to communicate during flights, the mobile device 102 may also report sensor information consistent with airline travel to permit confirmation of the status. For example, constantly changing GPS data from the mobile device 102, accelerometer data and/or barometric pressure data from a sensor on the mobile device 102 may all be used to confirm airline travel.

As another example, a user driving or riding in a car may be determined based upon TOD/DOW (e.g., the time and day being consistent with rush hour) in combination with GPS location information and accelerometer sensor readings. Constantly changing GPS data and accelerometer data from the mobile device 103 may be used to confirm that the user's status as driving.

As another example, the status of a user of a cell phone 104 in a business meeting may be inferred from TOD/DOW information compared against the user's Calendar. The TOD/DOW and calendar information may be maintained within the cell phone 104 and/or a server 109. Such a preliminary determination can be confirmed by considering other sensor information, such as GPS location information, and accelerometer and temperature sensor readings, and the cell phone 104 operating settings. For example, if the user has switched his mobile device 104 to vibrate or silent ring, these settings are consistent with the user being in a meeting and help to confirm the user's status. Similarly, if the GPS location is consistent with a conference room, the accelerometer readings show little significant movement and the temperature is consistent with an indoor location, this information can be used to confirm that the user is in a meeting. With the user's status so inferred, an appropriate avatar file can be selected or generated.

As another example, a user of a cell phone 104 may choose to display a set avatar while on vacation (e.g., an avatar sleeping in a hammock) instead of displaying current status. In this example, the cell phone 104 may be configured to not relay sensor data or communicate a set avatar, or a server 109 may be configured to ignore sensor data and TOD/DOW information and display a selected avatar.

In using a variety of sensors and information sources to infer a user's status, certain sensors or parameters may be given higher priority, particularly with respect to each other. For example, GPS location information may override TOD/DOW plus calendar information, such as when the GPS location is different from the location indicated by the calendar information. Logic rules may be generated to deal with such contradictory information. Additionally, user inputs and settings regarding current status may override all sensor, phone settings, or calendar parameter data.

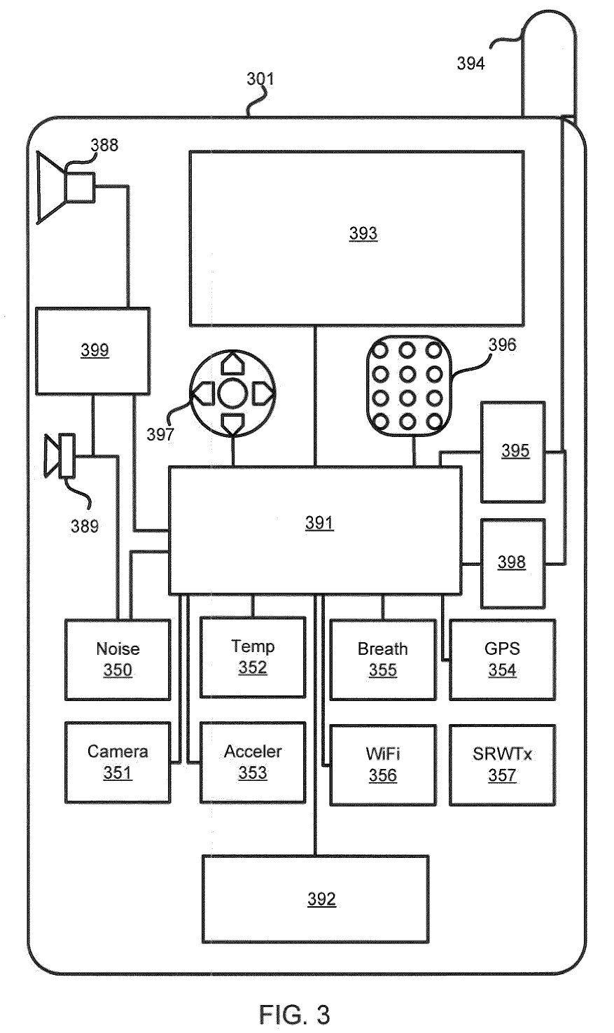

FIG. 3 illustrates a component block diagram of an embodiment of a mobile device suitable for use in the overview system. A typical mobile device 301 may include a microprocessor 391, a memory 392, an antenna 394, a display 393, an alphanumeric keypad 396, a 4-way menu selector rocker switch 397, a speaker 388, a microphone 389, a vocoder 399, a receiver 395, a transmitter 398, (together a cellular network transceiver) and various circuits, busses and electrical interconnections among these components. In addition, the mobile device 301 may include an ambient noise sensor 350 which is connected to the microphone 389 to detect ambient noise levels. The ambient noise sensor 350 may also function as a microphone for speaker phone operations. The mobile device 301 may also include a camera 351 which in addition to taking pictures can be used to measure ambient light levels. The mobile device may also contain an ambient temperature sensor 352 and one or more accelerometers 353 detecting the relative acceleration of the mobile device 301. The mobile device may also include a GPS receiver circuit 354 which is configured to receive signals from GPS satellites to determine the precise global position of the mobile device 301. The mobile device may also include a breathalyzer sensor 355 which is configured to measure a blood alcohol content (BAC) from a user's exhaled breath. Other biometric sensors may also be included, such as, for example, a blood pressure monitor, pulse rate sensor, EEG, ECG, EKG, etc. In embodiments where EEG sensors are included, a user's avatar may, for example, be displayed to be concentrating if the EEG sensor indicates brainwave patterns consistent with concentration levels. Alternatively, the user's avatar may be displayed to indicate the user in a relaxed mental state if the EEG sensor indicates brainwave patterns consistent with relaxation levels.

Each of the mobile device 301 sensors 350-356 are connected to the processor 391, which is in turn connected to an internal memory unit 392. In this manner, the processor 391 may collect parameter data from the various sensors 350-356 and may store the data in memory unit 392 or transmit the data via transmitter 398. It should be noted that while mobile device 301 is depicted in FIG. 3 as a mobile handset or cell phone, the system blocks may be found in any mobile device with wireless communication capability. In this way, other mobile devices such as a laptop computer, PDA or similar devices may be represented.

The various sensors illustrated in FIG. 3 can be used to more accurately infer a user's status and activities. For example, if the breathalyzer sensor 355 determines that the user's BAC is above 0.1%, indicating the user may be alcohol-impaired, the user's avatar could be selected or generated to indicate the impairment. As another example, if the accelerometer senses rhythmic motion consistent with jogging, an avatar may be selected or generated to indicate the user is exercising. This inferred status based on accelerometer sensor information may be confirmed compared with GPS readings to determine if the user is moving at a jogging pace or is located at a health facility. Also, if the mobile device 301 includes a blood pressure or pulse rate sensor (not shown), information from such sensors may be checked to determine if sensor values are consistent with exercise. Such sensors may enable distinguishing running or biking from traveling in a car, bus or train which could cause similar accelerometer and GPS information.

While FIG. 3 shows various sensors 350-356 electrically coupled to the processor 391 of mobile device 301, a wireless transceiver, such as WiFi transceiver 356, and a short range wireless transceiver (SRWTx) 357 may be incorporated to communicate with a variety of external sensors. One of skill in the art would appreciate the short range wireless communication transceiver 357 may be a Bluetooth protocol transceiver, Zigbee protocol transceiver, or other technology/protocol transceiver.

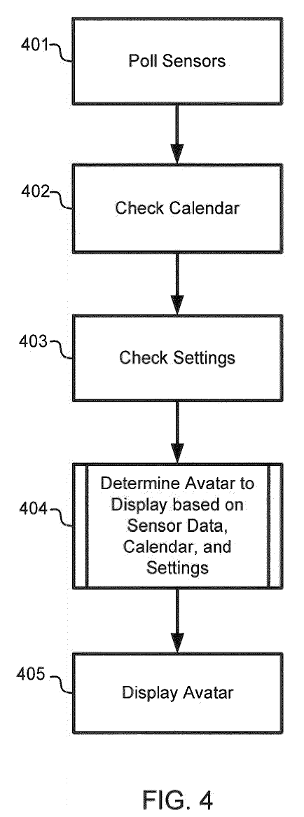

FIG. 4 illustrates basic process steps employed in various embodiments. As a first step, the processor 391 of the mobile device 301 may poll some or all of the sensors (e.g., 350-355) connected to the processor 391, step 401. As discussed above, the sensors may include external sensors that are wirelessly connected to the processor 391 via mid- to long-range wireless transceiver 356 and/or a short range wireless transceiver 357 included within the mobile device 301. The sensors may also be coupled to the processor 391 by various available ports or custom interface circuits. Further, the processor 391 may include multiple processors (i.e., processor 391 may be a multi-processor chip) with some sensors coupled to or interfacing with a processor and other sensors coupled to or interfacing with a second processor within the multiprocessor chip. In polling sensors, the processor 391 may access a data register where sensor data is buffered, or send a signal to the sensor (or sensor interface circuitry) directing it to take a reading and wait to receive sensor data. If the sensor is external to the mobile device 301, the processor 391 may send a data request message to the sensor via a wired or wireless data connection and then wait to receive sensor data in a response message via the same data link. Alternatively, the processor 391 may simply receive data transmitted by each of the sensors (e.g., 350-355) without prompting.

After, while, or before receiving sensor data, the processor 391 may also retrieve calendar data stored in memory 392, step 402. As discussed above, calendar data may be used to infer the activity and location of the user of the mobile device 301. Calendar data may be obtained for the particular time of day and day of week. As part of this step, the processor 391 may also obtain the current time and date that may be stored in a data register.

After, while, or before receiving sensor and calendar data, the processor 391 may retrieve various mobile device settings, step 403. Such device settings may include the selected ringer type (e.g., silent or audible), theme settings, normal or roaming communication mode, battery power level, current cellular communications status, such as whether the user is engaged in a phone call or accessing the Internet on a mobile browser, current wireless communications status, such as whether the user is presently connected to a WiFi network, and current local area wireless network status, such as whether the user is presently using a Bluetooth device. Each of these mobile device settings and operating conditions may provide information regarding the user's status. For example, if the user has set the mobile device 301 to display a casual theme (e.g., whimsical wallpaper, musical ringer, etc.) this may indicate that the user is not engaged in business or work activities.

In each of the various embodiments, the order of the method steps described herein may be varied from that illustrated in the figures. For example, the step of gathering sensor data may be performed after the step of gathering mobile device setting and calendar data. In this manner, the information provided by the device settings or indicated in the user's calendar may be used to make an initial inference regarding the user's activity which may be confirmed or further refined by selected sensor data. For example, if the device settings indicate that any cellular telephone call is in process, the mobile device processor 391 may be configured to poll only the GPS sensor, since the user's status (talking on a cell phone) is already established, and only the location remains to be determined. As another example, if the calendar data indicates that the user is in a meeting, the processor 391 may be configured with software to poll only those sensors necessary to confirm that status.

Using information gathered from mobile device sensors and stored data and settings, a processor can infer a user's current status and determine which one of a group of avatars to display, step 404. A variety of processors may be used to make this determination in the various embodiments. In one embodiment the processor 391 of the mobile device 301 is configured with software instructions to select an avatar for display based upon criteria stored in its memory 392. In such an embodiment, the avatar selected for display by the mobile device 301 may be uploaded to another computing device 113-117. For example, in an embodiment the selected avatar may be sent to another mobile computing device as an attachment to an e-mail or SMS message. In another embodiment, the mobile device can send a URL or other network address to another computing device to enable the receiving computer to obtain the avatar by accessing the provided URL or other address. In another embodiment, the mobile computing device 301 may transmit a memory pointer indicating that the memory storage location of the selected avatar file to another computing device so that the receiving computing device can obtain the avatar from its own memory. This embodiment may be employed where the avatar file is stored in memory (e.g., hard disc memory) of a server 109, thereby enabling the server to load the selected avatar to the user's webpage. This embodiment may also be employed with other computing devices 113-117.

In other embodiments, the mobile computing device 301 may transmit the sensor, calendar, and settings data to another computing device, such as server 109 or other computing devices 113-117, so that the avatar determination, step 404, can be performed by the processor of the receiving computing device. In such embodiments, the sensor, calendar, and settings data are received and stored in memory before the computing device's processor makes the avatar determination.

Once the proper avatar to display has been determined, the avatar file can be made available for display on a computing device 113-117, step 405. In an embodiment, the computing device 113-117 displays the selected avatar by accessing the avatar file that was either pre-stored in memory (e.g., using an address or memory pointer communicated by the mobile device 301) or downloaded from either the mobile device 101-104 or a server 109. In another embodiment, the avatar may be accessed and displayed as part of an Internet webpage hosted by a server 109. In alternative embodiments, the avatar files may be updated annually or some other period of time such that the avatar reflects the age of the user. As the user matures and grows older, the various avatar files may be updated to display an older and more mature avatar. For example, the avatar files may depict the user with graying hair or weight loss or gain as is appropriate with the actual appearance of the user. In this manner, when the appropriate avatar files is accessed or retrieved, the avatar will accurately reflect the user's age.

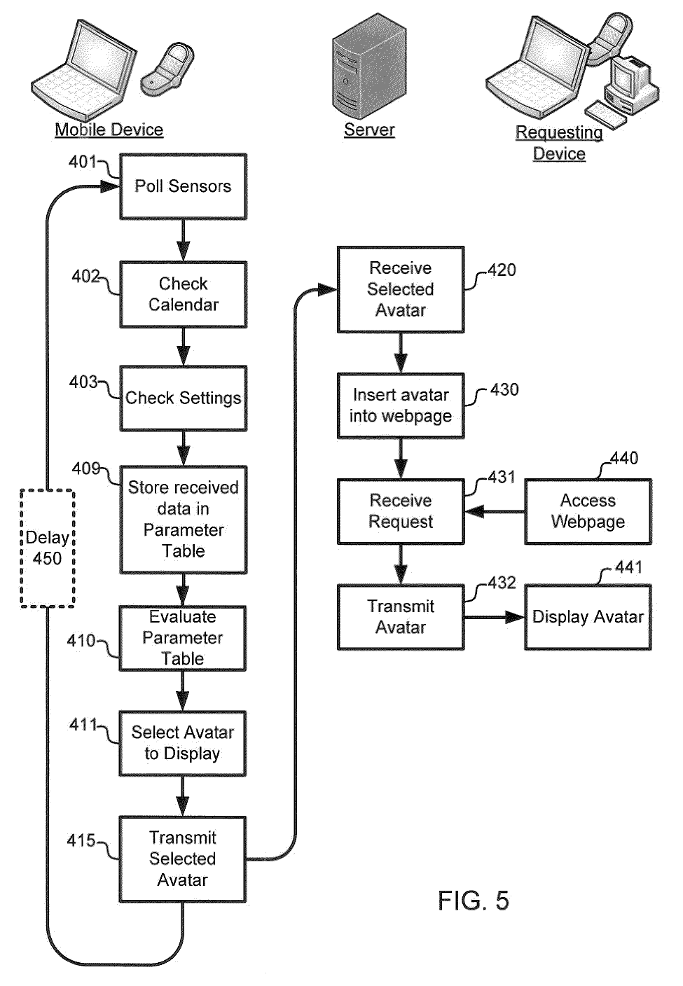

Specific process flow steps of the various embodiments will now be described in greater detail with reference to FIGS. 5-26.

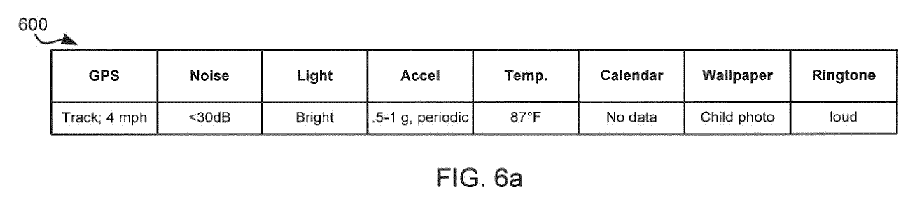

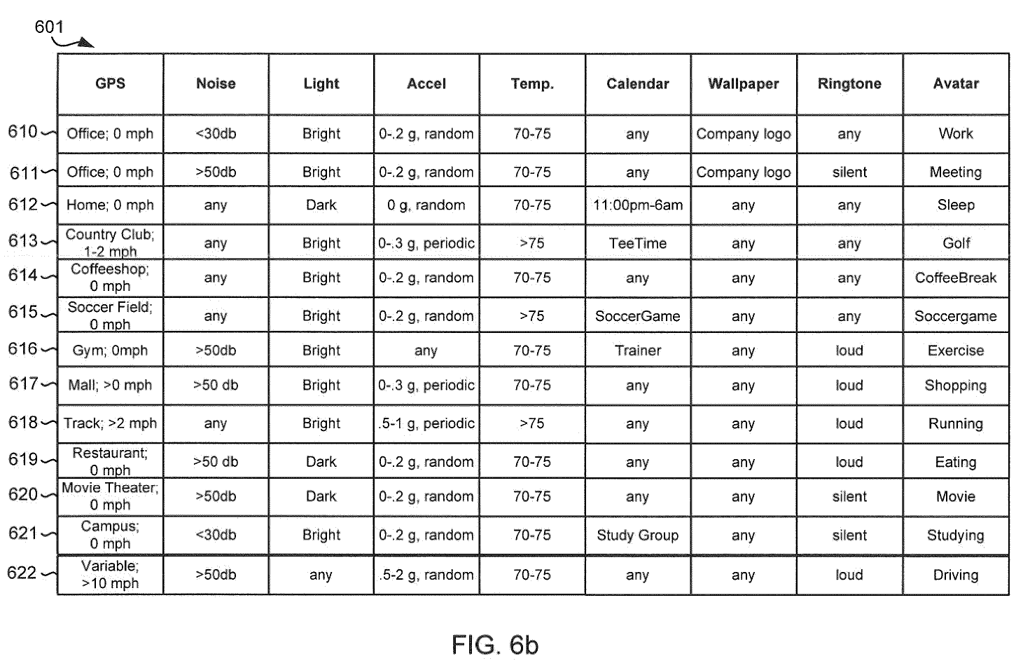

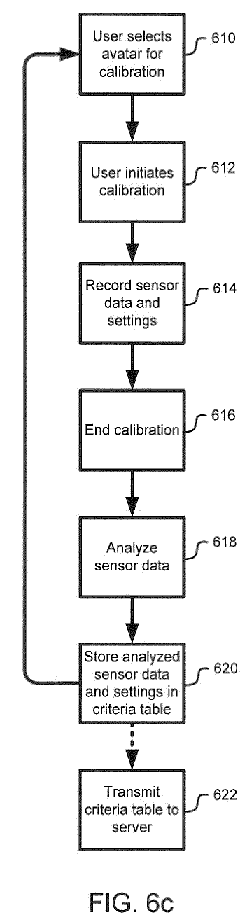

FIG. 5 is a process flow diagram of a first embodiment method in which the avatar to be displayed is determined by the mobile device 301 and is constantly updated to reflect the user's current status. In this embodiment, the mobile device 301 processor 391 periodically polls each of the sensors (e.g., 350-356) associated with the mobile device 301, step 401. In this step, the processor 391 may perform a loop in which each of the various sensors is polled, the associated sensor data received and stored in an appropriate data record within the mobile devices memory 392. The processor 391 also checks the calendar data stored in the memory 392, step 402. The calendar data may indicate where the user is expected to be and the particular activity the user is expected to be engaged in at the current time. The processor 391 also checks the various settings of the mobile device, step 403, including the current theme. As noted above, the order in which the processor 391 obtains data is not necessarily important and can vary among implementations. The processor 391 stores all of the sensor, calendar, and settings data in a parameter value table, step 409. The parameter value table will be discussed in more detail below with reference to FIG. 6a.

The processor 391 can evaluate the data stored in the parameter data table, step 410, to determine which avatar to display, step 411. A variety of method embodiments may be used to evaluate the stored parameter data and select a particular avatar for display. In a preferred embodiment, the parameters stored in the data table are compared to values stored in a selection table, such as illustrated in FIG. 6b. As described below in more detail with reference to that figure, a user may program his/her mobile device to select particular avatar by entering associated selection criteria in such a selection table. In this matter, any user can easily configure the mobile device to preferences and settings. In this embodiment, the processor 391 determines the avatar to display, step 411, by selecting the avatar for which the greatest number of selection criteria are satisfied by the parameters stored in the parameter data table.

In another embodiment, the parameter data may be evaluated in a logic tree programmed in software. In this example embodiment, the processor 391 executes a software routine in which the particular steps performed (e.g., a series of “if X, then Y” logic tests) depend upon certain parameter values. While the use of a programmed logic tree routine may operate faster, this embodiment may be more difficult for a user to configure and may allow fewer user selection options.

Once the appropriate avatar has been selected, the processor 391 can direct the transmitter 398 to transmit the selected avatar to a server 109 via a wireless or cellular network, and the Internet 108, step 415. In this step, the processor 391 may transmit the selected avatar file, a pointer or address to memory containing the selected avatar file, or an identifier of the selected avatar that the server 109 can use to locate the corresponding avatar file within its memory.

Once the selected avatar has been transmitted to the server 109, the processor 391 may periodically repeat the steps of obtaining parameter values so as to continually update the displayed avatar. If the user has generated appropriate avatars and configured the mobile device to appropriately link individual avatars to various parameter values, this embodiment can enable the server 109 to display an avatar that reflects the user's current status. In an embodiment, the processor 391 may optionally pause for a pre-determined amount of time before repeating the steps of obtaining parameter values in order to reduce the demand on the processor 391, step 450.

The transmitted data indicating a particular avatar to display is received by the server 109, step 420. The server processor (not shown separately) of the server 109 may include the selected avatar file in a webpage hosted on the server 109 for the user for public display, step 430. When a second user accesses the user's webpage, step 440, the access request is received by the server 109, step 431. In response, the server 109 transmits the webpage with the selected avatar file as an HTML file to the computing device 113-117 of the second user, step 432. The receiving computing device 113-117 then displays the selected avatar to the second user, step 441. Since the mobile device processor 391 is continually updating the avatar selection, this embodiment insures that whenever a second user accesses the first user's webpage, step 440, an avatar reflecting the first user's current status is displayed, step 441. Since the polling and analysis of sensor and settings data is performed autonomously, the user's avatar presented to others is maintained consistent with the user's current status without input by the user.

A variety of data structures may be used with the various embodiments, an example of which is displayed in FIG. 6a. As illustrated, data from sensors (e.g., 350-356), the user's calendar, and mobile device settings data can be stored in a parameter value table 600. Such data may be stored in the form of absolute values (i.e., the raw sensor information), or in the form of processed information (i.e., interpreted sensor information). This distinction turns on the amount of processing of the information that is done before it is stored in the parameter value table 600. For example, FIG. 6a illustrates processed GPS sensor information stored in the parameter value table 600 in which the raw geographic fix coordinate values have been interpreted and compared to a user created table of locations that enables the mobile device 301 to recognize that the device is currently located at the “Track” and is moving at a rate of about 4 mph. Similarly, raw data from an ambient noise sensor 350 has been processed and the recognized characteristic of less than 30 dB has been stored in the parameter value table 600. Similarly, ambient light sensor 351 data has been processed and a recognized characteristic of “bright” has been stored in the parameter value table 600. Similarly, accelerometer 353 data has been processed and stored as a range of acceleration values (in g's) and a recognized characteristic of the acceleration (periodic). Raw sensor data may also be stored directly in the parameter value table 600. For example, temperature sensor data of 87 degrees F. is stored in the table. Similarly, the fact that nothing is stored in the user's calendar for the present time is stored in the parameter value table 600 as either no data or a symbol indicating that no data is present in the calendar database. Similarly, the particular wallpaper employed on the mobile device 301 and the ring tone setting (‘loud’) are stored in the parameter value table 600.

The processed data values stored in the parameter value table 600 illustrated in FIG. 6a are for explanatory purposes only. As one of skill in the art would appreciate, sensor and setting data are more likely to be stored as digital data that can be interpreted by the processor 391. For example, processed data recognized as being consistent with the particular range or value may be stored as a symbol or binary value.

With sensor and setting data stored in a parameter value table 600, this information can easily be compared to criteria stored in an avatar selection logic table 601, an illustrative example of which is shown in FIG. 6b.

An avatar selection logic table 601 may be stored in memory of the computing device which determines the appropriate avatar to display. Thus, if the mobile device 301 determines the avatar to be displayed, such as described above with reference to FIG. 5, then the avatar selection logic table 601 will be stored in the memory of the computing device 301. In contrast, if the avatar selection is made by a server 109, then the avatar selection logic table 601 may be stored on the hard disk memory coupled to the server processor. Similarly, if another computing device 113-117 makes the avatar selection, then the avatar selection logic table 601 would be stored on that device. Additionally, the avatar selection logic table 601 may be stored on more than one computing device. For example, the avatar selection logic table 601 may be stored on the mobile device 301 and on a server 109 that hosts the user's avatar and webpage. Further, different versions of the avatar selection logic table 601 may be stored on different computing devices, enabling a user to vary the avatar selection criteria based upon the particular computer being used to make the selection. Thus, the avatar selection logic table 601 may be stored in the memory associated with each of these devices depending upon which embodiment is implemented. Additionally, the avatar selection logic table 601 may be transmitted from one device to another to enable the receiving computing device to make the avatar selection.

Using an avatar selection logic table 601 to perform the avatar selection provides greater user flexibility and control over the process. The various embodiments are intended to provide users with a flexible and accurate means for presenting avatar's reflecting their personal preferences and activities. Thus, there is benefit in giving users fine control over the process used to select and display the avatars of their choice. Use of a avatar selection logic table 601 also simplifies the user's setup process when many sensor and setting criteria are employed. A native application may be provided on the mobile device to enable a user to change the avatar selection criteria or otherwise manually control the avatar presented at any given time.

Users may customize the avatar selection logic table 601 such that the avatar file selected for display is chosen based upon a variety of parameters. This customization may be accomplished during a user setup process. Also, avatar selection criteria can be selected and the avatar selection logic table 601 populated during a user setup process in which the user makes personal selections in order to customize the user's own avatar behavior. Such a setup process may be accomplished with the aid of an interactive menu application running on a computing device. Such an interactive menu application may include user tools for creating and modifying and storing avatars, as well as menus for programming the avatar selection logic table 601. As part of the process for creating avatars, such a menu application may require the user to assign a name or descriptor of each avatar that can be saved in the avatar selection logic table 601. Once an avatar is created, or after all avatars have been created, the menu application may then prompt the user to enter values or ranges to be used as criteria for selecting each avatar, and store the user's responses in the appropriate fields of the avatar selection logic table 601.

For example, FIG. 6b shows a avatar selection logic table 601 in which a user has defined an avatar entitled “work”, stored as data record 610. For most users a “work” avatar will show a graphic representation of the user engaged in the user's occupation. In this example, selection criteria for the work avatar include: a location at the office and low velocity as recorded by a GPS sensor; low ambient noise; “bright” ambient light conditions; zero or low accelerometer readings (e.g., consistent with sitting or walking); and professional wallpaper settings (such as the company logo). The work avatar selection criteria may not include values for some parameters which the user anticipates are not likely to help resolve the user's status for that particular avatar. For example, the user has decided that the ambient temperature, calendar and ring tone values provide no additional conference value for selecting the work avatar. As a second example, the avatar selection logic table 601 includes a “meeting” avatar stored as data record 611. For this avatar, which is similar to the work avatar, the user has set ambient noise criteria at greater than 50 dB and added a ring tone=“silence” criterion.

Alternatively, the mobile device may be programmed with a software application to enable a user to populate the avatar selection logic table by performing an activity while recording sensor and setting data, and then identifying the avatar to associate with the recorded values. For example, a user that frequently jogs on a particular track may calibrate the avatar selection logic table by activating a calibration process while jogging at the track. In a calibration process, the mobile device 301 can record the sensor values and device settings during the activity, average the values, and store the average or range within the avatar selection logic table 601. In this manner, the mobile device can record the GPS coordinates of the track, the speed range of the user while jogging, the ambient noise, light and temperature conditions, and the accelerometer readings while jogging. In particular, some sensor values may exhibit characteristic patterns during particular activities that may be recognized and recorded in a calibration process. For example, an accelerometer may be able to recognize when a user is jogging based upon periodic accelerations with values and periodicity consistent with foot falls. The mobile device 301 may also record the device settings selected by the user during the activity.

FIG. 6c illustrates an example embodiment calibration method suitable for completing an avatar selection logic table. To begin the process, a user may select a particular avatar to be calibrated, step 610. This avatar may have already been created by the user and given a name. Alternatively, the user may enter a name for an avatar yet to be created. The user then begins the activity and initiates the calibration, such as by pressing a particular key on the mobile handset, step 612. During the activity, the mobile device 301 records this sensor data and device settings, step 614. For some sensors, this may involve recording sensor readings over a period of time along with the time of each recording in order to be able to recognize time-based patterns. After a period of time, the user may end the calibration, such as by a pressing a particular key on the mobile device, step 616. Alternatively, the calibration may proceed for a preset amount of time, so that step 616 occurs automatically.

Once calibration data gathering is completed, the processor 391 of the mobile device 301 can analyze the recorded sensor data using well-known statistical processes. For example, the sensor data may be statistically analyzed to determine the average sensor value and the standard deviation of sensor values. This calculation may be used to provide a mean with range (i.e., ±) value characterizing the particular activity. Alternatively, the sensor data may be analyzed to determine the maximum and minimum value, thereby determining the actual range of measurements during the activity. This analysis may be appropriate particularly for GPS coordinate values in order to determine the boundaries of the activity (e.g., perimeter of a jogging track). Sensor data may also be analyzed over time to determine characteristics of the values, such as whether accelerometer readings vary periodically, as may be the case while jogging or walking, or randomly, as may be the case in other activities. More sophisticated analysis of data may be employed as well, such as processing recorded ambient noise to detect and record particular noise patterns, such as the sound of an espresso machine. Once analyzed, the conclusions of the analyzed sensor data and mobile device settings may be stored in the avatar selection logic table 601 in a data record including the avatar name, step 620. The avatar selection logic table 601 may be stored in memory 392 of the mobile device 301. The user may repeat the process of selecting an avatar for calibration, engaging in the associated activity while allowing the mobile device 301 to perform a calibration routine and storing the analyzed sensor data in the avatar selection logic table 601 until criteria have been saved for all of the user's avatars. Optionally, when the avatar selection logic table 601 is completed, the table may be transmitted to another computing device, such as a server 109 on which the user's avatar is hosted, step 622.

Users may repeat the process illustrated in FIG. 6c at any time to update the calibration or criteria for a particular avatar or to add selection criteria for a newly created avatar.

Since users may not know the GPS coordinates of their various activities, and are unlikely to be able to accurately estimate ambient noise and accelerometer characteristics of an activity, this self-calibration method simplifies the process of setting up the avatar selection criteria. Further, users may not recognize how various activities impact their mobile device, and thus this embodiment method enables avatars to be selected based on as many sensors and setting values as can be recorded, even those of which the user may not be aware. For example, a coffee shop may have a number of characteristic background noises, such as the sound of an espresso machine, which the user may not notice.

The avatar selection avatar selection logic table 601 shown in FIG. 6b is intended for illustrative purposes only. More or fewer selection criteria may be included in the table depending upon the sensors and settings included in mobile device 301. The avatar selection table may also include fewer parameters if the user decides that the avatar to display can be determined using fewer parameters. The specific parameters associated with each avatar in the avatar selection table are merely illustrative and will be altered according to each individual user's preferences.

To select a particular avatar based upon the values stored in the parameter value table 600, a processor (be it in the mobile device 301, a server 109, or another computing device) can compare each value to corresponding criteria in the avatar selection logic table 601. A variety of algorithms may be employed to determine which of the avatar's selection criteria are most closely satisfied by any of the values in the parameter value table 600. In some implementations, a simple sum of the number of satisfied criteria may be sufficient to determine the appropriate avatar to assign. In an embodiment, weighting factors may be applied to selected criteria so that some measured sensor values are given greater weight when selecting an avatar. In another embodiment, one or two criteria may be used to make a preliminary determination of the current status, followed by a comparison of parameter values against confirmatory criteria. For example, GPS and calendar data may be used as primary indicators of particular activities, with noise, light and accelerometer data used to confirm the activity indicated by GPS location or calendar entries. For example, the GPS values stored in the parameter value table 600 most closely matches the criteria for the running avatar, data record 618. The running avatar can then be confirmed as an appropriate selection by comparing the accelerometer data with the corresponding criteria in the avatar selection logic table 601. In this example, the accelerometer data distinguishes the activity from driving by or walking near the track. By making such comparisons of the values stored in the parameter value table 600 to the criteria in the avatar selection logic table 601, a processor can determine that the “Running” avatar should be displayed. In another embodiment, the mobile device 301 may be configured with software instructions to ask the user whether it has correctly diagnosed the current activity (such as running), or ask the user to name the current activity. This method can enable the mobile device 301 to “learn” when parameters meet the desired criteria. Alternatively, in embodiments where avatar files and avatar selection logic tables are hosted on a remote server, the avatar selection logic tables of other previous users may be used to populate a new avatar selection logic table for a new user. For example, if a number of previous users have assigned a “jogging” avatar to a set of sensor data which includes a particular GPS location (track), accelerometer readings, noise, light, etc. sensor reading, then an artificial intelligence routine running on the server may recommend to the new user the “jogging” avatar when the same or similar set of sensor data is generated during a calibration routine. The artificial intelligence routine may analyze each of the hosted avatar selection logic tables to identify patterns or commonalities of assigned avatars and corresponding sensor data. By identifying these patterns, the server may recommend avatar based upon the sensor data gathered during a calibration process.

For many activities, the GPS sensor location and velocity data will provide a good indication of the avatar to display. However, in many situations multiple avatars may be associated with the same GPS location. For example, in data records 610 and 611 in the avatar selection logic table 601, both includes GPS location criteria of the user's office. This ambiguity may be resolved by considering the ambient noise level, which if it exceeds 50 dB would indicate a meeting, or considering the ringtone setting, which if it is set to “silent” would also indicate a meeting, indicating that the “Meeting” avatar should be displayed instead of the “Work” avatar. Alternative embodiments may ask the user (such as by way of a prompt presented on the display) the nature of an activity in order to learn and associate the recorded sensor and setting data with the specific activity. Instead of asking the user to define the nature of the activity, the mobile device 301 may ask the user to identify a particular avatar to be associated with the present activity in the future. In this manner, the displayed avatar may more accurately represent the user's status.

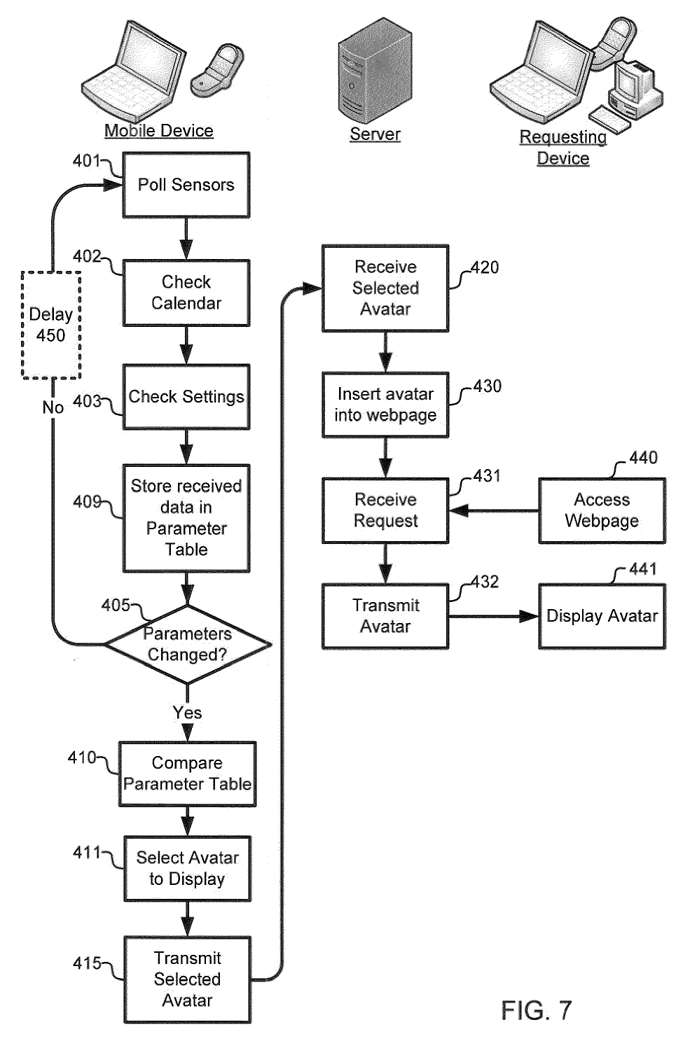

FIG. 7 is a process flow diagram of an alternative embodiment which conserves processing power of the mobile device by including a decision step 405 which determines if any of the parameters stored in parameter value table 600 has changed. If the sensor values and device settings are the same as those already stored in the parameter value table 600, in other words if no parameter value has changed, then no change in the avatar is required. Accordingly, the steps of selecting an avatar for display and transmitting the selection to a server (steps 410-415) do not need to be performed. Accordingly, if no parameter has changed in step 405, then the processor can return to the process of polling sensors and checking settings, steps 401-409. Optionally, steps 401-409 may be repeated after some predetermined delay, step 450, to reduce the amount of processing time dedicated to monitoring sensors. When the processor determines that a value in the parameter value table 600 has changed, then the method can continue on to select a particular avatar for display and transmit the avatar to a server, steps 410-441, in a manner similar to that described above with reference to FIG. 5.

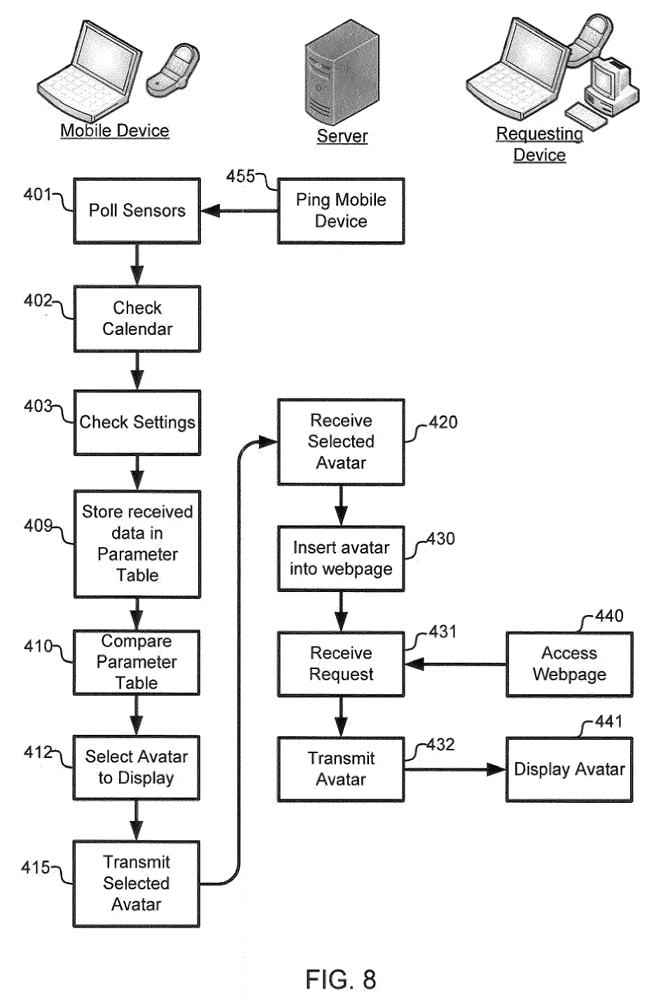

FIG. 8 is a process flow diagram of an embodiment which conserves processing power of the mobile device 301 by only polling sensors, checking device settings and selecting an avatar for display, steps 401-415 when prompted by the server 109 hosting the user's webpage. In this embodiment, the server 109 periodically transmits a request to the mobile device 301 requesting it to transmit the current avatar, step 455. The process of requesting an update from the mobile device 301 is referred to in the figures as a “ping” of the mobile device 301 The server 109 may send a request for the avatar to the mobile device 301 periodically or at pre-determined times in order to maintain on the user's website an avatar reflecting the current status of the user. In response to receiving a request for an avatar or a “ping” from the server 109, the processor 391 of the mobile device 301 conducts the process of polling sensors, step 401, checking calendar data, step 402, checking device settings, step 403, storing the data in a primer value table, step 409, selecting an avatar for display by comparing the parameter values to avatar selection, steps 410, 412, and transmitting the selected avatar to the server 109, step 415, all in a manner similar to that described above with reference to FIG. 5.

Depending upon the periodicity of“pings” from the server 109, step 455, the user may complete and change activities between avatar updates. As a result, the displayed avatar may not always accurately represent the user's current status. The currency of the displayed avatar can be enhanced by increasing the frequency of avatar update requests sent to the mobile device, step 455, but at the cost of additional processing overhead. Similarly, by increasing the period between avatar update requests sent to the mobile device, step 455, mobile device 301 may reduce processing overhead. Thus, by varying the periodicity of avatar update requests sent to the mobile device, step 455, a trade-off can be managed between currency and mobile device processor overhead.

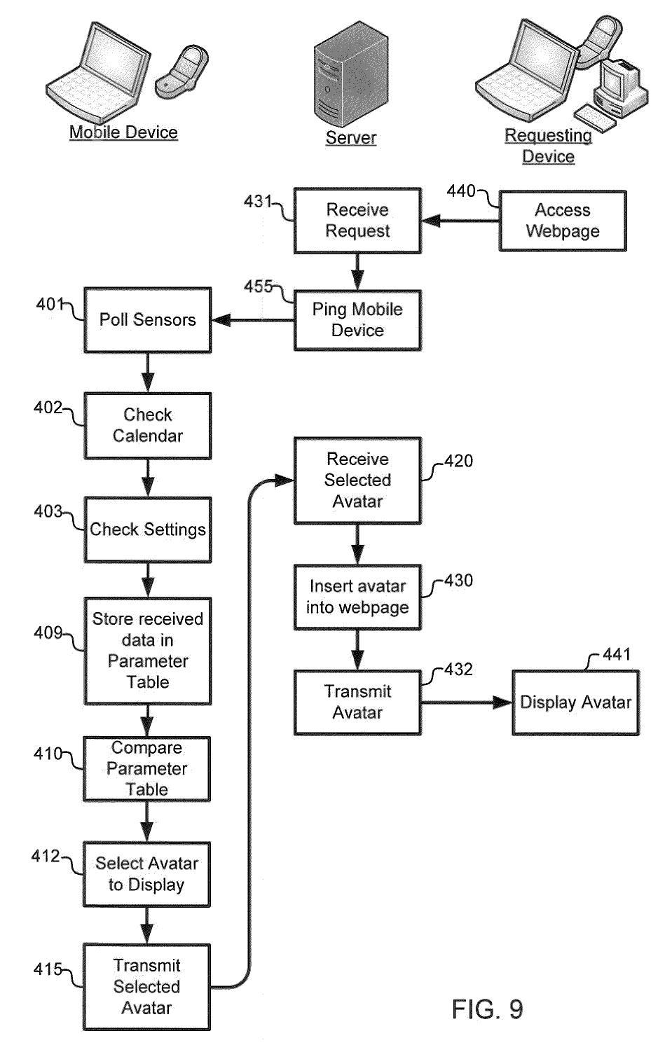

FIG. 9 is a process flow diagram of another embodiment which conserves processing power of the mobile device 301 by only polling sensors, checking device settings and selecting an avatar for display, steps 401-415, when the server 109 receives a request for the user's avatar. When someone would like to view the user's avatar, they may send a request to access the user's webpage containing the avatar to the server 109, step 440. When the server 109 receives the request for the user's avatar, step 431, the server 109 sends an avatar update request to the mobile device, step 455. In response to receiving a request for an avatar or a “ping” from the server 109, the processor 391 of the mobile device 301 conducts the process of polling sensors, step 401, checking calendar data, step 402, checking device settings, step 403, storing the data in a primer value table, step 409, selecting an avatar for display by comparing the parameter values to avatar selection, steps 410, 412, and transmitting the selected avatar to the server 109, step 415, all in a manner similar to that described above with reference to FIG. 5. Upon receiving the selected avatar file from the mobile device, step 420, the server 109 can insert the avatar into the user's webpage, step 430, and transmit the webpage including the avatar to the requester, step 432, where it can be displayed by the requester's browser, step 441. In this manner, the mobile device 301 only has to poll the sensors and retrieve calendar and device settings data when a second user wants to view the user's avatar. This minimizes the processing resources of the mobile device 109 dedicated to providing current status avatars. While the embodiment illustrated in FIG. 9 may result in a slight delay before the requester can view the avatar, the resulting avatar will accurately reflect the user's current status.

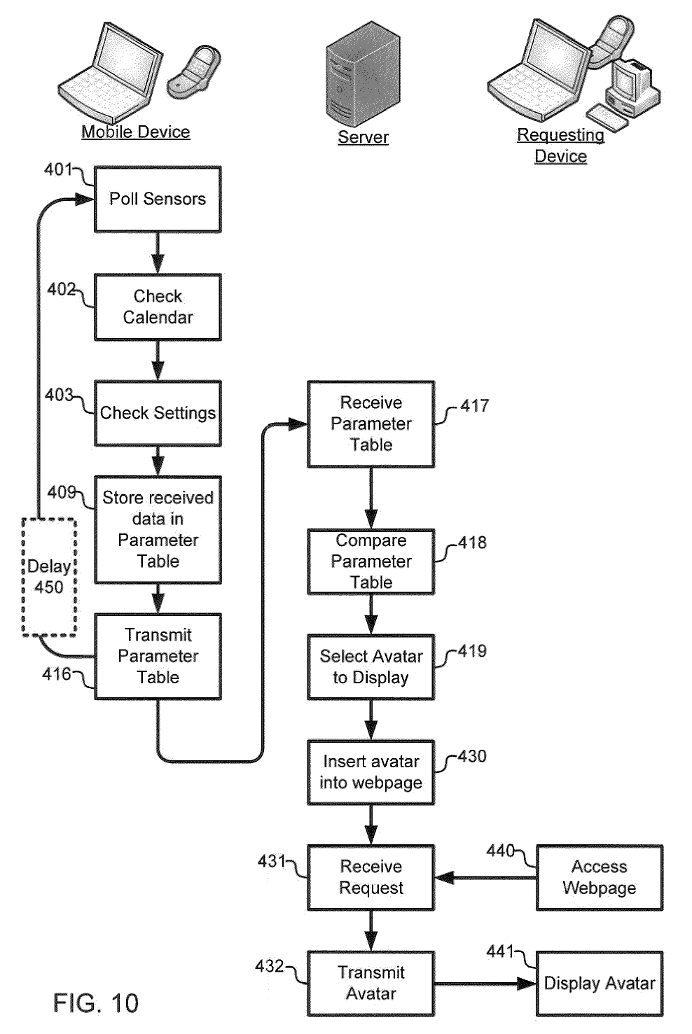

FIG. 10 is a process flow diagram of an embodiment in which the selection of the avatar is made by the server 109 which hosts the user's webpage. In this embodiment, the process of polling sensors, checking calendar data and recording device settings in any parameter value table, steps 401-409, are substantially the same as those described above with reference to FIG. 5. Instead of comparing the parameter values to avatar selection criteria within the mobile device 301, the mobile device transmits the parameter value table to the server 109, step 416. As discussed above, the data is saved in the parameter value table 600 and transmitted to the server 109 in step 416 may be processed data or raw sensor data, depending upon implementation. Once the parameter value table 600 is transmitted to the server 109, step 416, the processor 391 of the mobile device 301 may repeat the process of polling sensors, etc., steps 401-409, so that the sensor and setting data reflecting the user's current status is transmitted periodically to the server 109. Optionally, the mobile device processor 391 may pause, step 450, before repeating polling and recording steps 401-404.

The parameter value table 600 is received by the server 109, step 417, where the table may be stored in hard disk memory. In the alternative embodiment, mobile device 301 may transmit sensor parameter values sequentially to the server 109, which then can populate the parameter value table 600 as the data is received in step 417. Once the parameter value table 600 has been received, the values may be compared to avatar selection criteria in the avatar selection logic table 601, step 418. The process of comparing parameter values to the avatar selection criteria may be accomplished in the server 109 in a manner substantially similar to that described above with reference to step 411 and FIG. 5. Based upon the comparison in step 418, the server 109 selects an appropriate avatar for display, step 419, and prepares the avatar for display, such as by inserting the avatar into the user's webpage hosted by the server 109. By keeping the user's parameter value table 600 up-to-date, an avatar reflecting the user's current status will be displayed when, in response to someone accessing the avatar, step 440, the server 109 transmits the avatar, step 432, for display on the requester's computing device, step 441. This embodiment obviates the need for the mobile device to select the appropriate avatar and transmit the avatar to the server, thereby reducing processor overhead and saving power. Because most mobile devices 301 are limited in their processing power and battery potential, offloading the avatar selection to the server 109 processor can enable the mobile device 301 operate longer on a single battery charge.

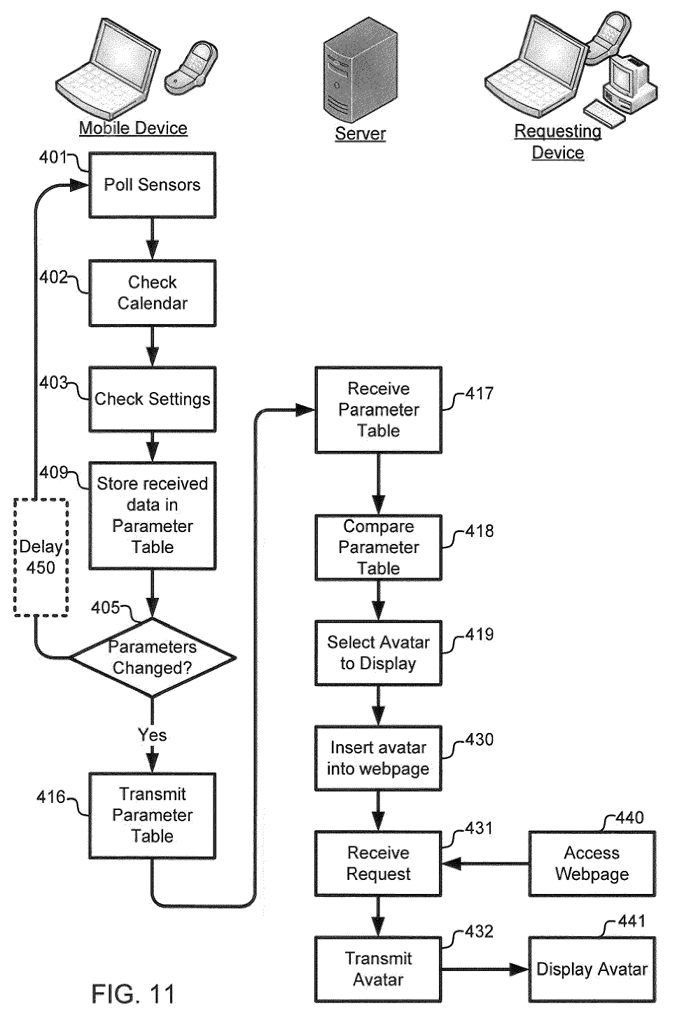

FIG. 11 illustrates an alternative embodiment in which the avatar selection is performed by a server 109, but the mobile device 301 only transmits sensor, calendar and setting data if such data has changed. The processing of this embodiment is substantially the same as described above with reference to FIG. 10 with the addition of a test, step 405, to determine if any parameter values have changed since the last transmission of the parameter value table, step 416. If no parameter values have changed, then the processor 391 of the mobile device 301 repeats the process of polling sensors etc., steps 401-409, after an optional pause, step 450. Only if a parameter value has changed does the mobile device transmit the updated parameter value table to the server 109, step 416. This embodiment has the added advantage of transmitting the parameter value table only when an update to the values stored on the server 109 is required. Thus, this embodiment further saves on mobile device battery use.

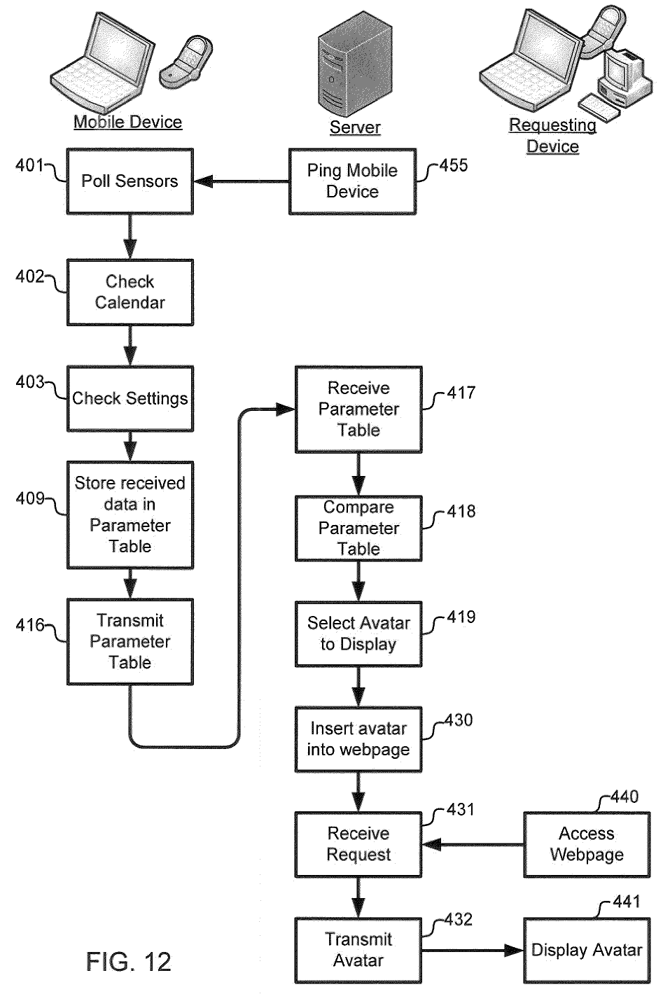

FIG. 12 illustrates an alternative embodiment in which the avatar selection is conducted by the server 109 periodically requesting updates from the mobile device 301. In a manner similar to that described above with reference to FIG. 8, the server 109 periodically requests an update of the parameter value table 600, step 455. In response, the mobile device 301 polls sensors, etc. and transmits the parameter value table 600 to the server 109 as described above with reference to steps 401-416 in FIG. 10. The rest of the steps in this embodiment are substantially the same as described above with reference to FIG. 10. This embodiment further reduces mobile device 301 battery consumption by limiting the polling of sensors, etc. to a periodicity that is controlled by the server 109. As explained above with reference to FIG. 8, the trade-off between avatar currency and battery consumption can be controlled by varying periodicity of requests made to the mobile device 301. Alternative embodiments may also employ sensors which “sleep” and awaken when only when some parameter (e.g., noise, light, acceleration, change of location, etc.) is detected.

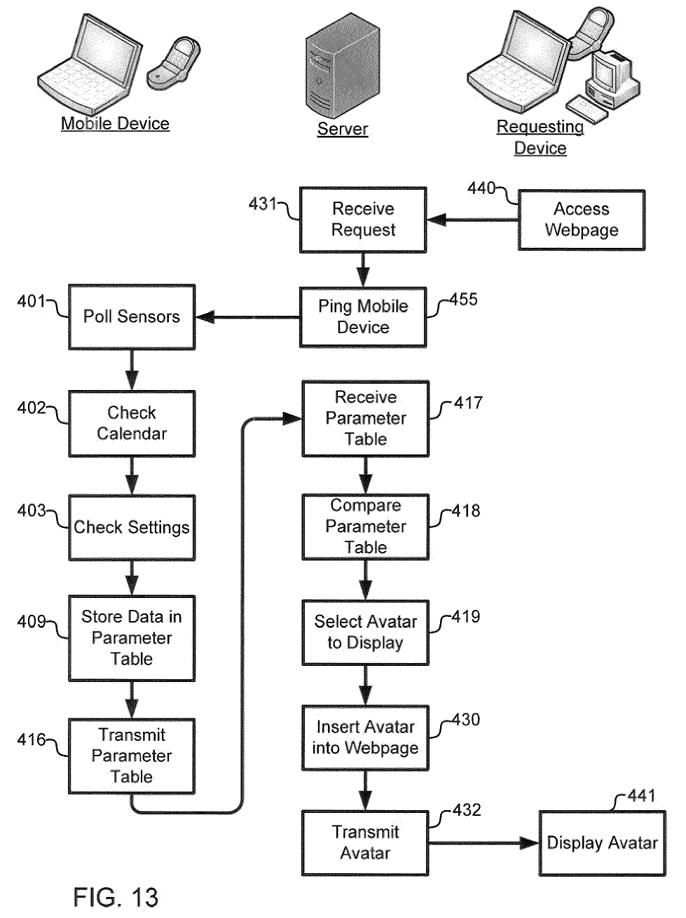

FIG. 13 illustrates another alternative embodiment in which the avatar selection is conducted by the server 109 in response to requests from others to view the avatar. In a manner similar to that described above with reference to FIG. 9, when someone sends a request to access the user's avatar, step 440, the server 109 receives the request, step 431, and in response sends an avatar update request to the mobile device, step 455. In response, the mobile device 301 polls sensors etc., and transmits the parameter value table 600 to the server 109 as described above with reference to steps 401-416 in FIGS. 10 and 12. The rest of the steps in this embodiment are substantially the same as described above with reference to like numbered steps in FIG. 10. This embodiment even further conserves battery power by limiting the polling of sensors and transmission of data to occasions when someone accesses the user's avatar.

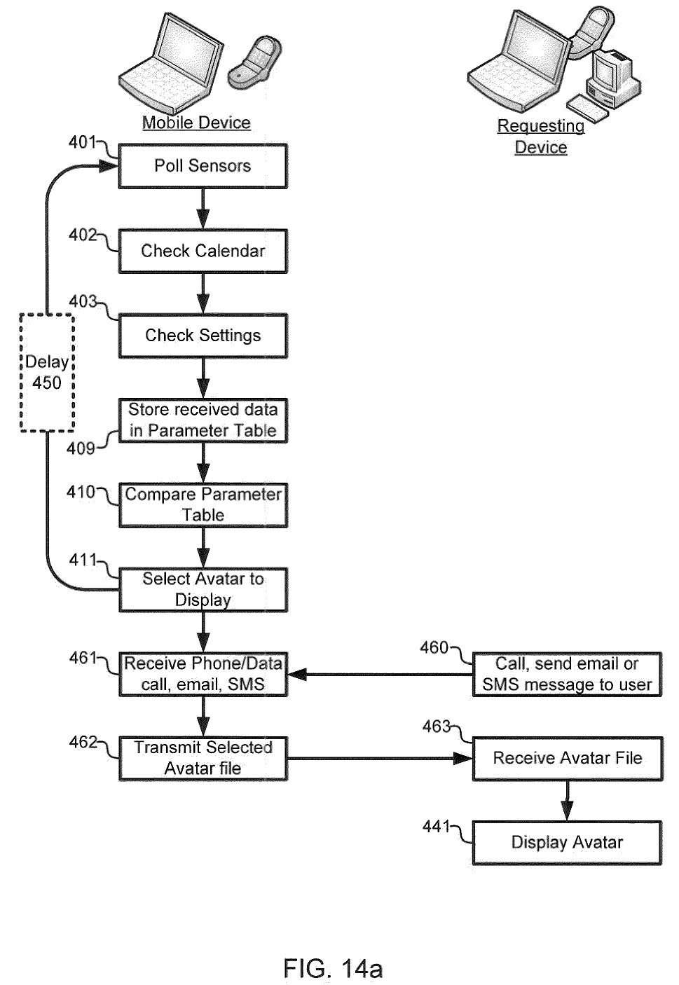

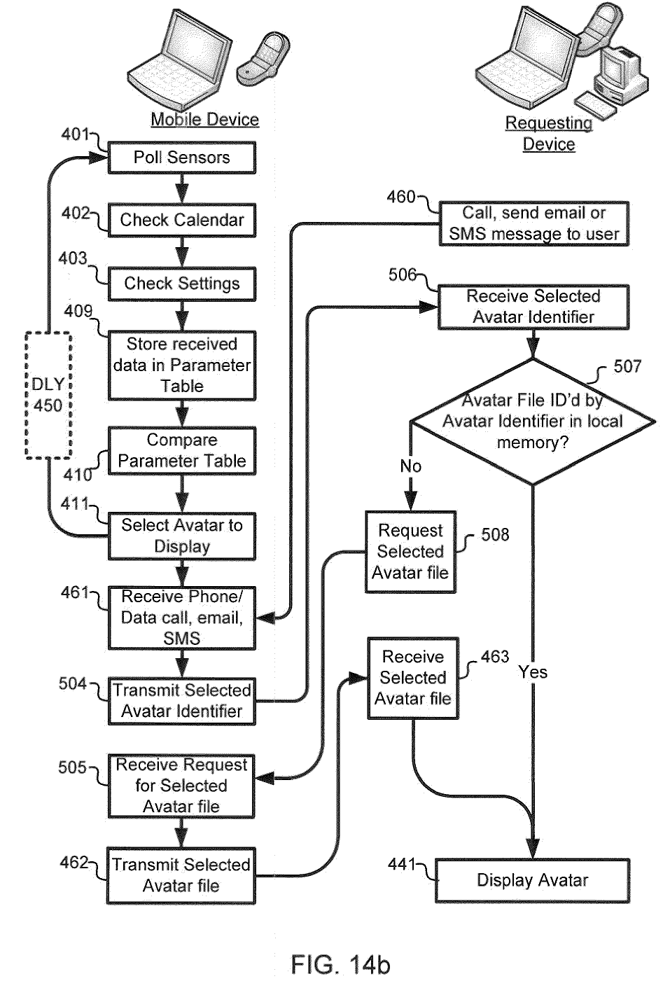

The foregoing embodiments were described with reference to a server 109 which serves as a host or access point for a user's avatar. These embodiments make use of the current Internet architecture in which avatars are maintained on servers to provide their accessibility. However, alternative embodiments may permit the display of a user's avatar on a second user's computing device (e.g., 113-117) without the need to access a server 109. In these embodiments, avatar files are stored on either the first user's mobile device 301 or the second user's device 313-317, or both. Because the storage and display of avatar files may require significant memory storage space and processor time (particularly if the avatar file is three-dimensional or animated) pre-authorization to request and receive avatar files between the users may be desired. An illustrative embodiment of such a method to display a user's avatar is shown in FIG. 14a.

Referring to FIG. 14a, the processing within the mobile device 301 is substantially similar to that described above with reference to FIG. 5 up to the point where the avatar is selected, step 411. The mobile device 301 may continuously poll the sensors, step 401, and checks calendar and settings data, steps 402, 403, to collect data regarding the user's current status. The gathered data can be stored in a parameter value table 600, step 409, and compared against an avatar selection avatar selection logic table 601, step 410. Based upon the comparison, an avatar file to display is selected, step 411. In this manner, the avatar selection is continuously updated so that the selected avatar reflects the user's current status. In order to conserve battery power and reduce processor overhead, an optional pause or delay, step 450, may be taken between polling cycles.

The foregoing process steps ensure that the mobile device 301 has a current avatar selection stored in memory. A request for the avatar may be sent by a second user, step 460, by e-mail, SMS message and/or a phone call. In response to receiving a request for the avatar, step 461, the mobile device 301 processor 391 recalls the avatar file from memory and transmits the file to the requester, step 462. Upon receiving the avatar file, step 463, the requesting computing device can then display the avatar, step 441.

In an embodiment the processor 391 may compare the source (e.g., return address or telephone number) of the contact request against a list of pre-approved second user devices (e.g., 113-117) to determine if the requesting device is authorized to receive the user's avatar. This list of preapproved users can be similar to a list of friends and family telephone numbers and e-mail addresses.

In an embodiment, a plurality of the user's avatar files can be pre-stored on the device initiating contact, such as on all computing devices that are preapproved to receive the user's avatar. Unlike the foregoing embodiment where the entire avatar file is transmitted to the requester, only the avatar name needs to be transmitted in order for any requester to recall the avatar file from its own memory. By pre-storing avatar files on pre-approved computing devices, the delay between the avatar request and its presentation to the requester or is minimized since only the avatar name is transmitted. However, such embodiments may require significant storage requirements on multiple devices as well as time required to download all of the user's avatar files to each preapproved computing device.

In an alternative embodiment, the avatar files may be pre-stored on the pre-approved computing device as well as directly transmitted to the pre-approved computing device. In order to minimize power consumption required by both the mobile device 301 and the requesting device, only an identifier of the selected avatar file is transmitted to the second user's device. The alternative embodiment checks the local memory of the requesting device to determine whether the transmission of the avatar file is necessary or not. If the avatar file already exists in the local memory of the requesting device, then the avatar file is immediately displayed. If the avatar file does not exist in local memory, then a request for the avatar file is made and subsequently transmitted for display. FIG. 14b illustrates an alternative embodiment which is substantially the same as the embodiment described above with reference to FIG. 14a with the exception that an avatar file identifier (ID) is transmitted to the requesting device in step 504. The requesting device receives the avatar ID, step 506, and uses the ID to determine if the associated avatar file is already stored in its memory, test 507. If the avatar file corresponding the the ID already exists in the local memory (i.e., test, 507=Yes), the avatar is promptly displayed, step 441. However, if the avatar file corresponding to the ID is not already in memory (i.e., test 507=No), the requesting device requests the file to be transmitted, step 508. The request is received by the mobile device 301, step 505, and the corresponding avatar file is transmitted, step 462. Thereafter the requesting device receives the avatar file, step 463, and displays it, step 441. As an optional step, not shown, the received avatar file may be stored in local memory for future use. In this manner the alternative embodiment allows for the display of new or updated avatar files. In addition, power consumption is conserved by both the mobile device 301 and the requesting device by only requiring the transmission of a large avatar file when the requesting device does not already have the avatar file in local memory. By limiting the amount of data transmitted, the alternative embodiment also conserves transmission bandwidth.

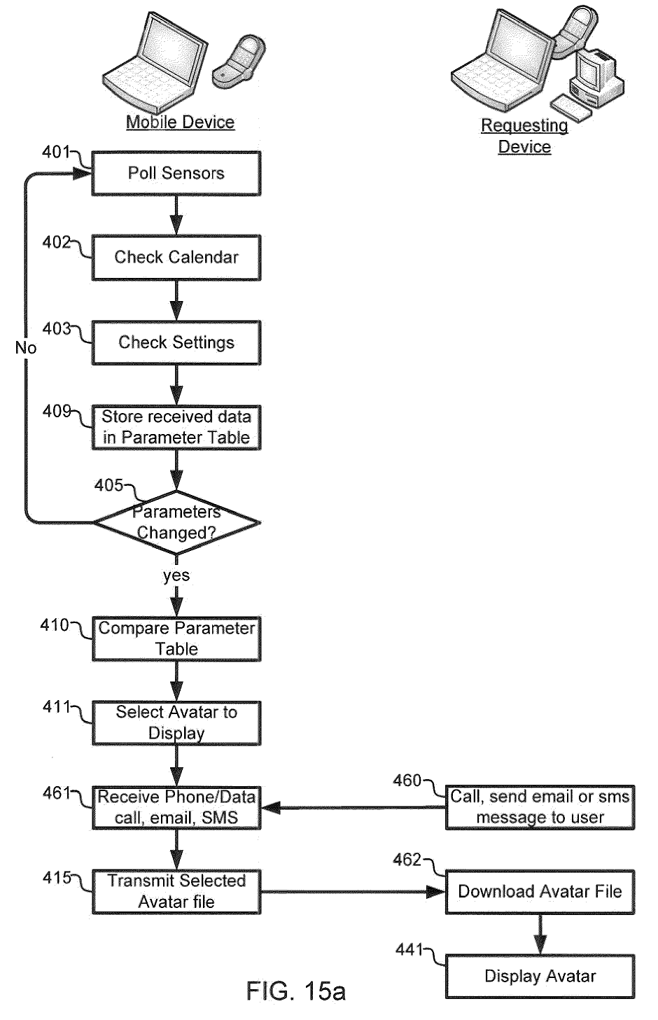

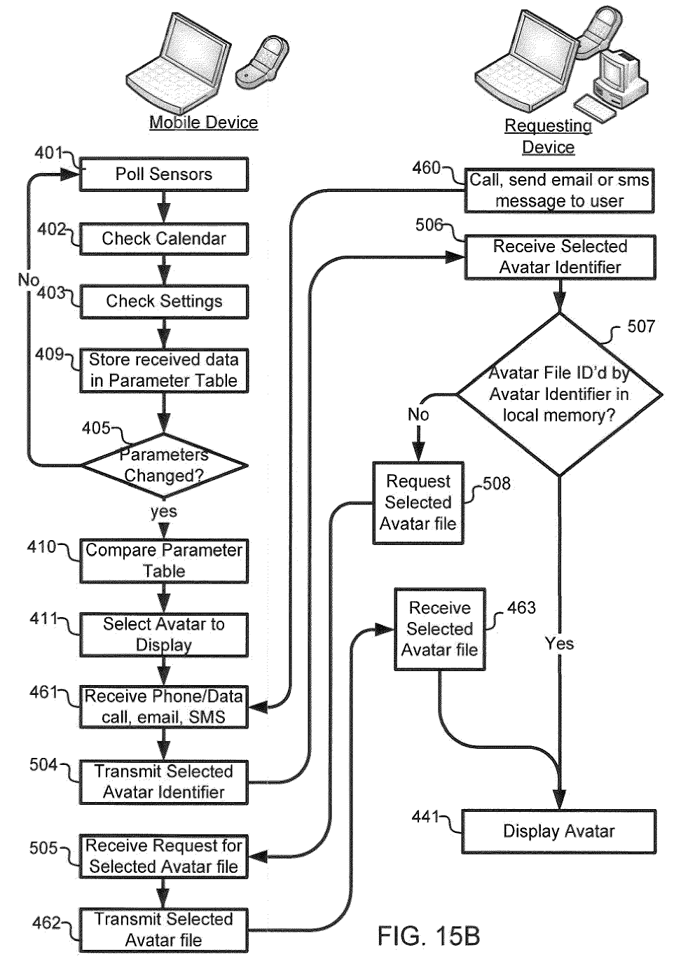

FIG. 15a illustrates an alternative to the foregoing embodiment shown in FIG. 14a, which includes a test, step 405, to determine if any a parameter has changed. As described more fully above with reference to step 405 in FIG. 7, if no parameter has changed since the last avatar selection, step 411, then the processor 391 may continue to collect sensor, calendar and settings data, steps 401-409. If a parameter has changed, then the method may continue as described above with reference to like numbered steps in FIG. 14.

Similar to the manner in which the embodiment illustrated in FIG. 14b modified the method of FIG. 14a, the embodiment shown in FIG. 15b modifies the method shown in FIG. 15a. The alternative embodiment shown in FIG. 15b conserves processing power, battery life and transmission bandwidth and further allows for the use of updated or new avatar files. Similar to the embodiment shown in FIG. 14b, the embodiment shown in FIG. 15b modifies the method shown in FIG. 15a by further including steps 504-508 which transmit only an identifier of the selected avatar file to the second user's device. The local memory of the requesting device is checked to determine whether the transmission of the avatar file is necessary or not. If the avatar file already exists in the local memory of the requesting device, then the avatar file is immediately displayed. If the avatar file does not exist in local memory, then a request for the avatar file is made and subsequently transmitted for display.

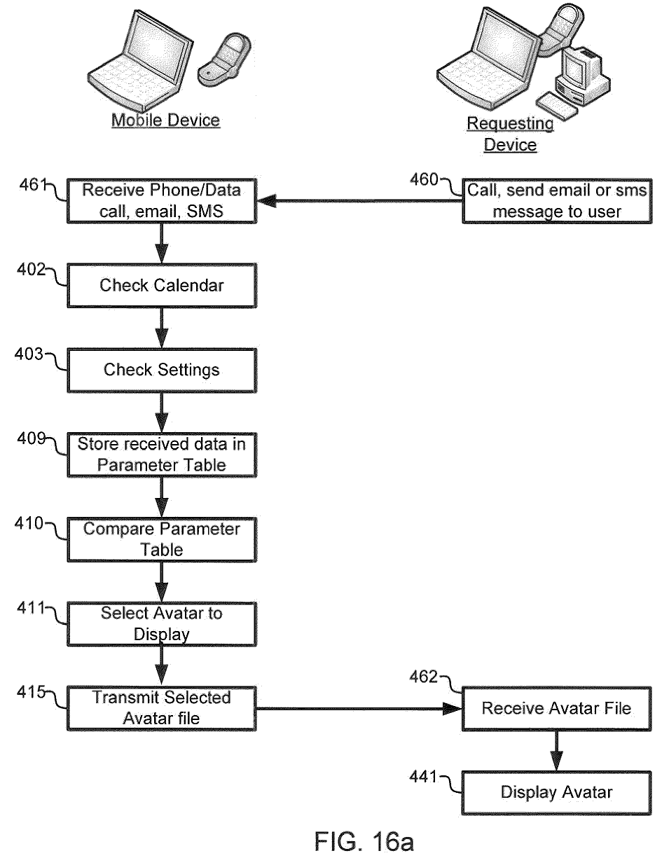

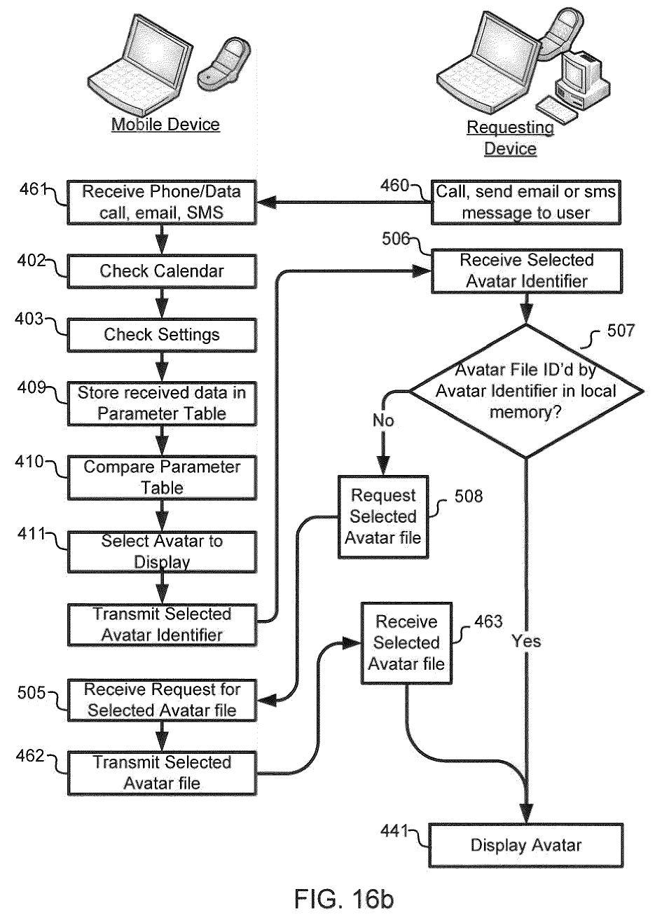

FIG. 16 illustrates an alternative embodiment which further conserves processor and battery time of the mobile device 301 by responding to an avatar request made by a second user. An avatar request may be transmitted to the mobile device 301 by a second user, step 460. The avatar request is received by the mobile device 301, step 461, and in response the processor 391 gathers and stores sensor, calendar and settings data, steps 401-409, as described above with reference to FIG. 5. The processor 391 then compares the gathered data in a parameter value table 600 to an avatar selection logic table 601, step 410, to select an avatar for display, step 411. The processor 391 then transmits the selected avatar file to the requesting computing device, step 415, which receives the avatar file, step 462, and displays the selected avatar, step 441.

In an embodiment the processor 391 may compare the source (e.g., return address or telephone number) of the contact request against a list of pre-approved second user devices (e.g., 113-117) to determine if the requesting device is authorized to receive the user's avatar. This list of preapproved users can be similar to a list of friends and family telephone numbers and e-mail addresses.

In an embodiment, a plurality of the user's avatar files can be pre-stored on the computing device initiating requesting an avatar. For example the user's avatar files may be stored on all computing devices that are preapproved to receive the user's avatar. Unlike the foregoing embodiment where the entire avatar file is transmitted to the requester, only the avatar name needs to be transmitted in order for any requester to recall the avatar file from its own memory. By pre-storing avatar files on pre-approved computing devices, the delay between the avatar request and its presentation to the requester is minimized since only the avatar name is transmitted. However, such embodiments may require significant storage requirements on multiple devices as well as time required to download all of the user's avatar files to each preapproved computing device.

Alternatively, similar to the embodiments shown in FIG. 14b and 15b, the embodiment shown in FIG. 16b modifies the embodiment method shown in FIG. 16a by adding steps 504-508 which transmit only an identifier of the selected avatar file to the second user's device. The local memory of the requesting device is checked to determine whether the transmission of the avatar file is necessary or not. If the avatar file already exists in the local memory of the requesting device, then the avatar file is immediately displayed. If the avatar file does not exist in local memory, then a request for the avatar file is made and subsequently transmitted for display.

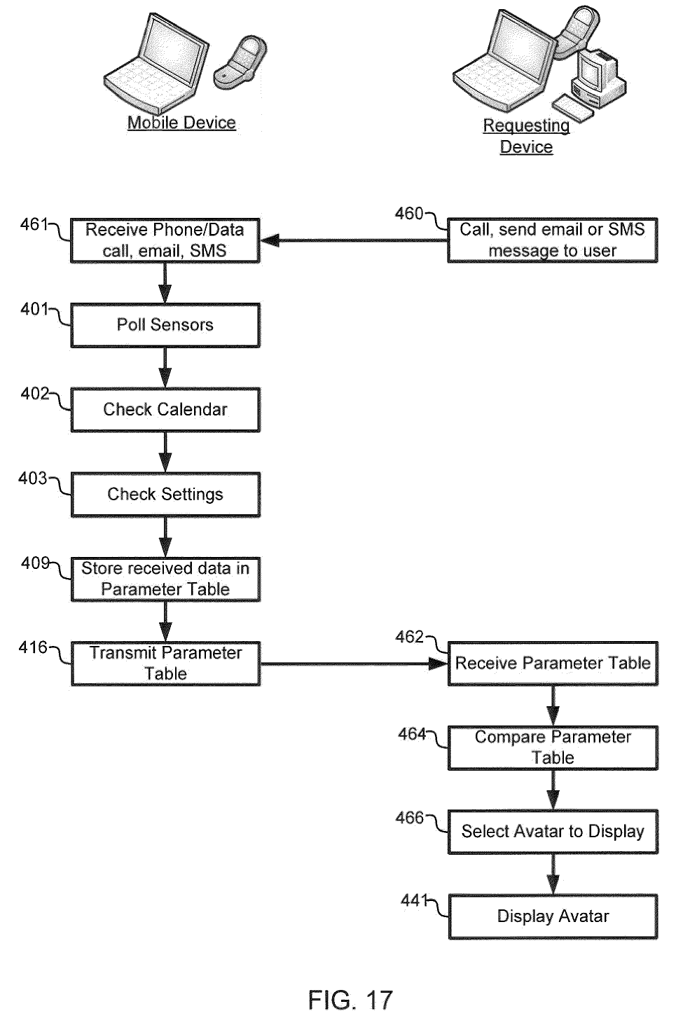

In an embodiment illustrated in FIG. 17 the avatar files and avatar selection logic table 601 are pre-stored on computing devices that are authorized to request the user's avatar. In this embodiment, a preapproved computing device requests an avatar, step 460, such as by calling, sending an e-mail, or sending an SMS message to the user. In response to receiving the request for an avatar, step 461, the processor 391 of the mobile device 301 polls sensors, checks calendar data and checks device settings, steps 401-403, and stores the data in a parameter value table 600, step 409, and as described more fully above with reference to FIG. 5. The processor 391 then transmits the parameter value table 600 to the requesting computing device, step 416. The requesting computing device receives the parameter value table, step 462, and compares the values to an avatar selection logic table 601 stored on the computing device, step 464, in order to select the appropriate avatar for display, step 466. Having selected the appropriate avatar, the computing device then calls the avatar from its memory, and displays it, step 441. The process by which the avatar-requesting computing device compares parameter values to avatar selection criteria, steps 464 and 466, are substantially the same as similar steps described above as performed by the mobile device 301 or server 109.

In alternative embodiments, the user may also set authorization selection criteria to control who may view each avatar, at what times, and during what activities. A user may provide a plurality of avatars corresponding to the same sensor settings but differing depending upon the identity of a requester (i.e., the second user making the request). Some avatars may provide less detail regarding the user's exact activity or may differ significantly from the activity in which the user is actually engaged. Further, a user may set authorization controls to override sensor information to ensure the displayed avatar does not correspond to the user's actual activity.

For example, a user may set authorization levels to ensure that the user's boss may only view an avatar detailing the user's activity during work hours. At other times the avatar may be denied or hidden, or if an avatar is present, it may be a simple avatar indicating that the user is busy without depicting the activity in which the user is engaged. In another example, a user may set authorization levels (also referred to as permission controls) so that the user's boss may view an avatar depicting the user at work, when the sensor data indicates that the user is at the gym.

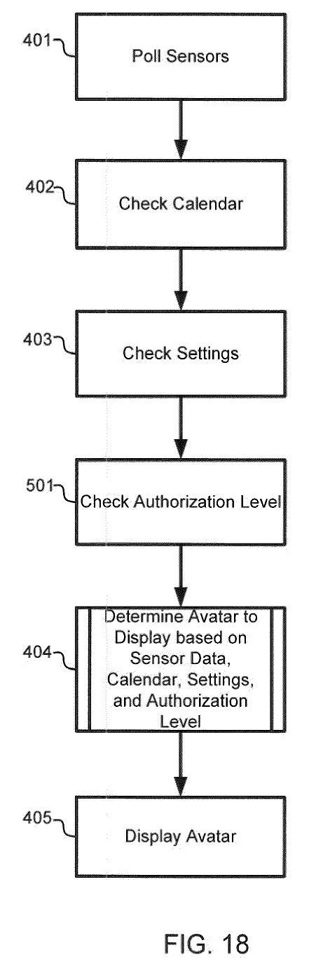

FIG. 18 illustrates example process steps that may be employed in embodiments which select an avatar based in part upon an authorization level of a requestor. As described above with reference to FIG. 4, the mobile device processor 391 may retrieve various pieces of data regarding the user's current activity, steps 401-403. Once relevant data regarding the user's current activity is collected, the authorization level of the requestor is determined, step 501. Various methods to determine the requestor's authorization level are described in more detail below. Once the authorization level of the requestor is determined it may be used as another parameter to select the appropriate avatar to display. In embodiments where the avatar is sent directly from the mobile device 301 to the requestor's device, the mobile device's processor 391 may check the authorization level of the requestor. In instances where the avatar is stored and inserted into a webpage at a central server location, the processor of the server or the processor of the mobile device may perform the step of checking the authorization level of the requestor.

Any of a variety of methods may be implemented to check a requestor's authorization level. For example, a requestor may be asked to provide some form of authentication credential, such as a user name and password to verify that the requestor is authorized to receive an avatar and/or has a particular authorization level. Alternatively, some specific computing devices may be authorized to view selected avatars. The processor may check a static internet protocol (IP) address of computing device submitting a request for the avatar to determine if the computing device is authorized to receive the avatar, such as by comparing the static IP address received in the avatar request message to a list of static IP addresses authorized to receive the avatar. Any method which authenticates a requestor or a computing device transmitting a request to receive an avatar as an authorized user/device or categorizes a requestor or device into various authorization levels may be used in the various methods to perform the step of checking the authorization level of a requestor. Once the determination is made of whether the requestor is authorized to receive a particular avatar (or the level of the requestor's authorization), this criterion may be entered into the parameter table as another criterion to determine which avatar to display or transmit to the requestor.

Using information gathered from the various mobile device sensors, the various mobile device settings and calendar data, a processor can infer a user's current status. Combining this inference with the requestor's authorization level, the processor may select an avatar to display in accordance with the user's preferences, step 404. As discussed above with respect to the various embodiments illustrated in FIGS. 5-17, a variety of processors may be used to make this determination. For example, the determination of which avatar to display may be made by the processor of the mobile device 301, the server 109, or the requestor's computing device. In addition, once the appropriate avatar has been selected, it may be displayed in any of the ways described above. For example, the avatar may be displayed as part of a webpage hosted by a server, displayed directly on the requestor's computing device, or attached as an image file sent in an e-mail, SMS or other message.

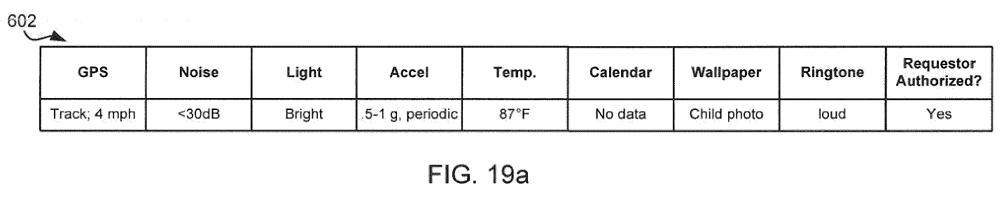

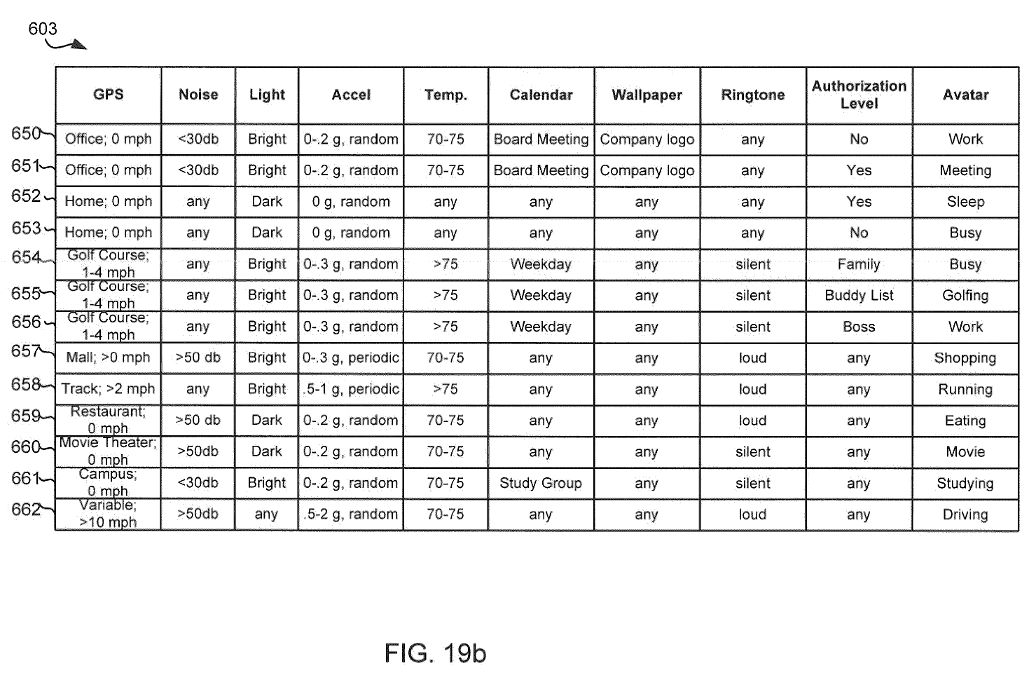

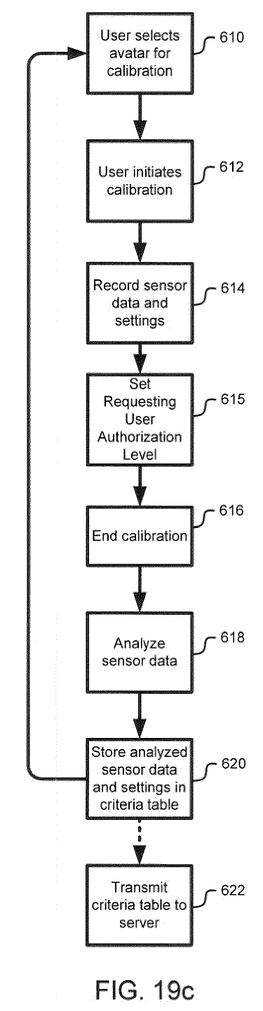

Similar to embodiments discussed above, data from mobile device sensors (e.g., 350-356), the user's calendar, and the mobile device settings can be stored in a parameter value table 602. Such data may be stored in the form of absolute values (i.e., the raw sensor information), or in the form of processed information (i.e., interpreted sensor information). This distinction turns on the amount of processing of the information that is done before it is stored in the parameter value table 602. In addition, the parameter table 602 may include an additional column for recording whether the requestor is authorized or the requestor's authorization level, if there are more than two levels. For example, FIG. 19a illustrates a parameter value table 602 similar to the parameter value table described above with reference to FIG. 6 with the addition of a column titled “authorization level” storing the results of the authorization level check performed in step 501. In the illustrated example the authorization level check has determined that the requestor is authorized.

With sensor, calendar, setting data and the authorization level of the requestor stored in a parameter value table 602, this information can be compared to criteria stored in an avatar selection logic table 603. An illustrative example of an avatar selection logic table 603 is shown in FIG. 19b, which is similar to the selection logic table 601 described above with reference to FIG. 6b. The avatar selection logic table 603 of FIG. 19b includes an additional parameter column which records selection criteria relating to the authorization level of the requestor.

As described above with reference to FIG. 6b, the avatar selection logic table 603 shown in FIG. 19b may be stored in memory of the computing device which determines the appropriate avatar to display. As previously discussed with reference to FIG. 6b, using an avatar selection logic table 603 to perform the avatar selection provides users with flexibility and control over the selection process. Users may customize the avatar selection logic table 603 such that the avatar selected for display is chosen based upon a variety of parameters including the authorization level of the requestor. The avatar selection logic table 603 provides users with the additional option of assigning different avatars for display based on the authorization levels of the requestor. This customization of the avatar selection logic table 603 may be accomplished during a user setup process. Any of the setup methods discussed above for populating the avatar selection logic table 601 may be implemented to construct the avatar selection logic table 603.

The authorization level may be simply a binary level denoting whether a requestor is authorized. In such a binary system, two different avatars may be displayed for identical selection criteria of sensor, calendar and settings data depending on whether the requestor is authorized. For example, a more general avatar may be displayed in instances where the requestor is not authorized while a detailed or more accurate avatar may be displayed for the identical selection criteria of sensor, calendar and setting data if the requestor is authorized. The first user may simply elect to assign a value of “no avatar,” meaning that no avatar is to be displayed or transmitted if the requestor is not authorized. Alternatively, a first user may set multiple levels of authorization, each resulting in the display of a different avatar for identical selection criteria of sensor, calendar and settings values.

In the example illustrated in FIG. 19b, for identical sensor, calendar and setting data the user has defined in data records 650 and 651 two different avatars entitled “work” and “meeting,” respectively. The avatar selection process is accomplished in the same manner as described above with respect to avatar selection table logic 601. In this example, selection criteria for both data records 650 and 651 include: a location at the office and low velocity as recorded by a GPS sensor; low ambient noise; “bright” ambient light conditions; zero or low accelerometer readings (e.g., consistent with sitting or walking); calendar data indicating that a meeting is scheduled and professional wallpaper settings (such as the company logo). The “work” and “meeting” avatar selection criteria may not include values for some parameters which the user anticipates are not likely to help resolve the user's status for that particular avatar. For example, the user has decided that the ambient temperature and ring tone values provide no additional value for selecting either the work or meeting avatar. If the sensor and setting data stored in the parameter value table 602 match the criteria in data records 650 and 651, a different avatar will be selected and displayed depending on the authorization level of the requestor (in this case whether the user is authorized or not). If the requestor is not authorized (i.e., authorization level=“no”), this may mean that the requester is merely a member of the general public not known to the user. For such general public members, the user may want to indicate that the user is at work and not disclose the exact activity in which the user is currently engaged. Thus, while the calendar parameter may indicate that the user is currently in a “Board Meeting,” the avatar displayed to an unauthorized requester is the more generic “Work” avatar of the user engaged in the user's occupation.

In contrast, if the requester is authorized (i.e., authorization level stored in table 602 is “yes”), this may mean that the requestor is a co-worker, boss, or family member (for example) to which the user wants to disclose an accurate avatar. For such requesters, the user may wish to accurately indicate the activity in which the user is engaged so that more information will be conveyed to a known requestor. Thus, if the requestor is authorized, the “meeting” avatar may be displayed showing the user engaged in a meeting or presentation.

In the case of data records 652 and 653, the selection criteria include: a location at home and low velocity as recorded by a GPS sensor; “dark” ambient light conditions; zero accelerometer readings (e.g., consistent with sitting or sleeping). Both data records 652 and 653 may not include values for some parameters which the user anticipates are not likely to help resolve the user's status for that particular avatar. For example, the user has decided that the ambient temperature, calendar data, wallpaper and ring tone values provide no additional conference value for selecting either the avatar to display. Rather, the user may feel that if the user is at home, the user is likely sleeping. However, the user may not want to indicate to co-workers or more specifically the user's boss that the user is sleeping. Thus, only authorized requestors, such as friends and family members, will receive the “sleeping” avatar. Non-authorized requesters such as the user's boss will simply be receive a “busy” avatar according to the selection criteria in data record 653.

A user may program the avatar selection logic table 603 with multiple levels of authorization such that more than two different avatars may be displayed for the identical sensor, calendar and settings data depending upon the authorization level of the requestor. For example, in data records 654-656, the selection criteria includes: a location at the golf course and low velocity as recorded by a GPS sensor; “Bright” ambient light conditions; zero to low accelerometer readings (e.g., consistent with walking or riding in a golf cart); ambient temperature being greater than 75 degrees; and a calendar setting indicating a weekday. In such circumstances, the user may not wish to inform either the user's spouse or boss that the user is golfing on a weekday during business hours. Accordingly, a requester whose authorization level indicates that the requestor is on the user's buddy list will be sent the “golfing” avatar (see data record 655). However, the user's spouse may have a authorization level of “family” which causes the “busy” avatar to be selected for display. Additionally, the user's boss may have an authorization level which would cause a “work” avatar to be selected for display.

Users may populate the avatar selection logic table 603 in a manner similar to that described above with reference to FIG. 6c. FIG. 19c illustrates an example embodiment calibration method suitable for completing an avatar selection logic table that includes a requestor's authorization level. To begin the process, a user may select a particular avatar to calibrate, step 610. This avatar may have already been created by the user and given a name. Alternatively, the user may enter a name for an avatar yet to be created. The user then begins the activity and initiates the calibration, such as by pressing a particular key on the mobile handset, step 612. During the activity, the mobile device 301 records sensor data and device settings, step 614. For some sensors this may involve recording sensor readings over a period of time along with the time of each recording in order to be able to recognize time-based patterns. Alternatively, the user may be permitted to take multiple number of sensor readings and average the sensor readings to refine the calibration of parameter readings for an avatar. For example, avatars may be displayed to indicate an increasing or decreasing effort on the part of a user during an exercise session depending on the refined heart rate sensor readings. After a period of time, the user may end the calibration, such as by a pressing a particular key on the mobile device, step 616. Alternatively, the calibration may proceed for a preset amount of time, so that step 616 occurs automatically. After the sensor data and device settings have been recorded, step 614, the user is given the option of adding an authorization level to the data record, step 615. The user may be prompted to select alternative avatars for the recorded sensor and setting data. The user may be further prompted to select an authorization level corresponding the selected alternative avatar such that requestor's possessing the selected authorization level will receive the selected alternative avatar whenever the sensor and settings match the recorded criteria. Once calibration data gathering is completed, the processor 391 of the mobile device 301 can analyze the recorded sensor data using well-known statistical processes as described more fully above with reference to FIG. 6c.

Once analyzed, the conclusions of the analyzed sensor data and mobile device settings may be stored in the avatar selection logic table 603 in a data record including the authorization level and avatar name, step 620. The avatar selection logic table 603 may be stored in memory 392 of the mobile device 301. The user may repeat the process of selecting an avatar for calibration, engaging in the associated activity while allowing the mobile device 301 to perform a calibration routine and storing the analyzed sensor data in the avatar selection logic table 603 until criteria have been saved for all of the user's avatars. This may include multiple avatar settings for different authorization levels. Optionally, when the avatar selection logic table 603 is completed, the table may be transmitted to another computing device, such as a server 109 on which the user's avatar is hosted, step 622. In addition, a learning method as described above with respect to avatar selection logic table 601 may be implemented.

Users may repeat the process illustrated in FIG. 19c at any time to update the calibration or criteria for a particular avatar or to add selection criteria for a newly created avatar.

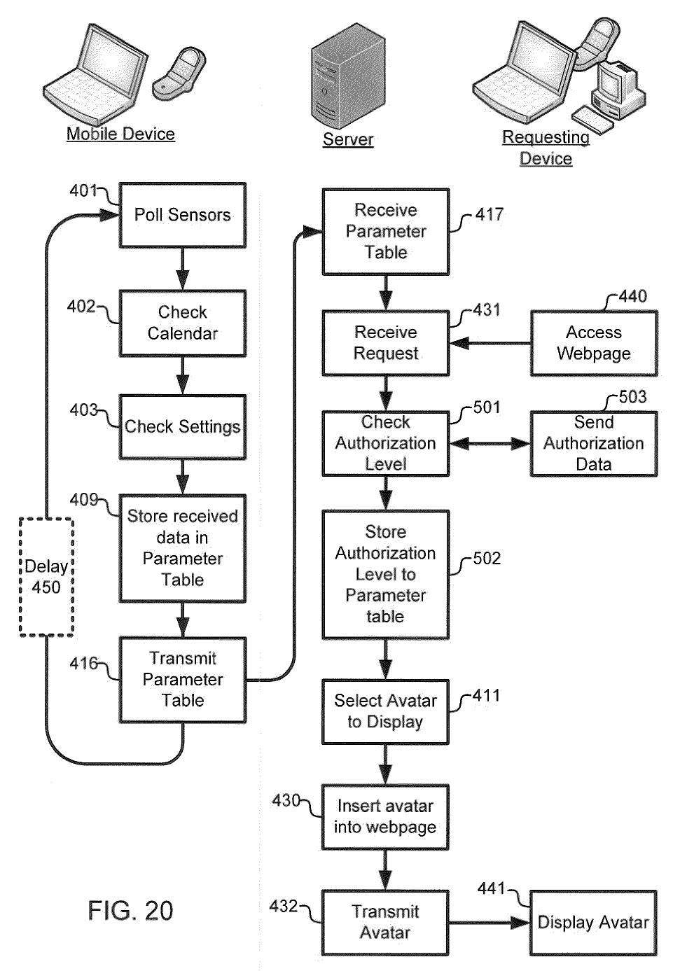

FIG. 20 is a process flow diagram of an embodiment method in which the avatar to be displayed is determined based upon the sensor and setting data as well as the requestor's authorization level. In this embodiment, the mobile device 301 processor 391 performs steps 401-431 in a manner substantially the same as described above with reference to FIGS. 5-12.

Once the webpage access request is received, the processor of the server 109 can implement any of a number of methods discussed previously to check the authorization level of the person or device requesting access to the webpage(the “second user”), step 501. Data regarding the second user may be sent from the second user's device back to the server 109 processor to complete the check authorization level step, step 503.

Once the authorization level of the second user is determined, this information is stored in the parameter table held in memory of the server 109. The data record of the parameter table is compared against the criteria in an avatar selection logic table 603 stored in memory of the server 109 to determine which avatar to display, step 411. As described more fully above, a variety of method embodiments may be used to evaluate the stored parameter data and select a particular avatar for display. For example, the processor of the server 109 may select the avatar the avatar for which the greatest number of selection criteria are satisfied by the parameters stored in the parameter data table. Once the appropriate avatar has been selected, the processor of server 109 can insert the selected avatar into the webpage and sent to the requestor as described more fully above with reference to FIGS. 5-12 for steps 430-441. Since the polling and analysis of sensor and settings data is performed autonomously, the user's avatar presented to others is maintained consistent with the user's current status without input by the user unless the user has elected to alter the avatar to be selected based upon the requestor's authorization level.

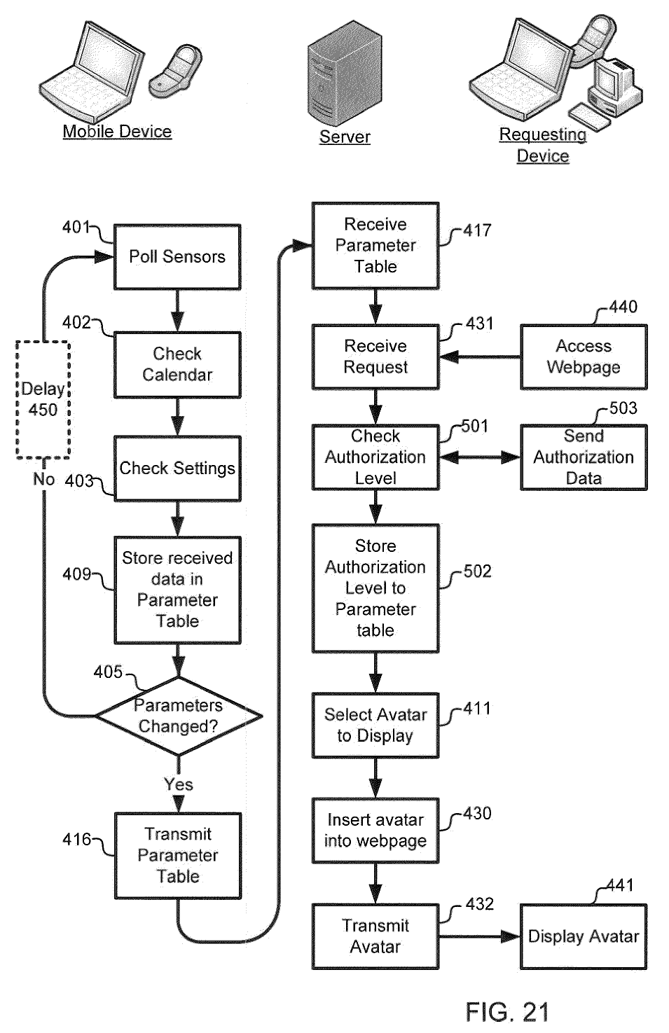

FIG. 21 is a process flow diagram of an embodiment method suitable for implementation on a mobile handset which conserves battery and processor time and determines an avatar to display based upon an avatar selection logic table which includes data related to the authorization level of the second user. The embodiment illustrated in FIG. 21 includes steps 401-440 described above with reference to FIGS. 5-12. The processor selects an avatar to display in the same manner as described above with reference to FIG. 20 for steps 501-503 and 411. Once the appropriate avatar has been selected, the processor of server 109 can insert the selected avatar into the webpage and sent to the requestor as described more fully above with reference to FIGS. 5-12 for steps 430-441.

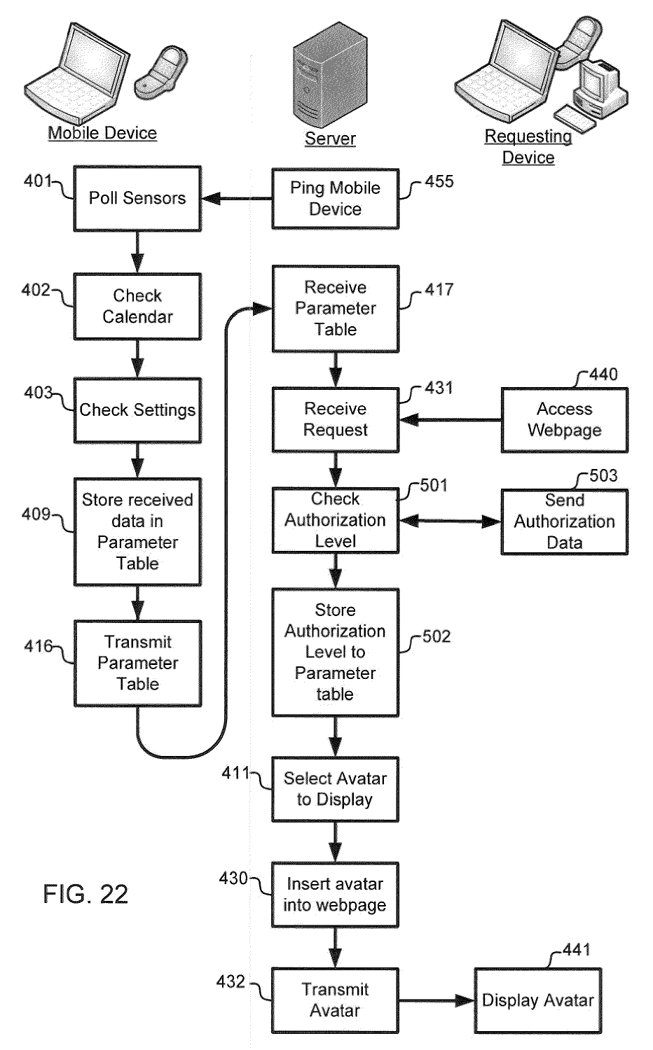

FIG. 22 is a process flow diagram of an embodiment which conserves processing power of the mobile device 301 by only polling sensors, checking device settings, steps 401-409, when prompted by the server 109 hosting the user's webpage, step 455. This embodiment includes the steps 401-455 described above with reference to FIGS. 5-12. The processor receives and checks the requestor's authorization level, steps 501-503, and selects the appropriate avatar, step 411, as described above with reference to FIGS. 20 and 21. Once the appropriate avatar has been selected, the processor of server 109 can insert the selected avatar into the webpage and sent to the requestor as described more fully above with reference to FIGS. 5-12 for steps 430-441.

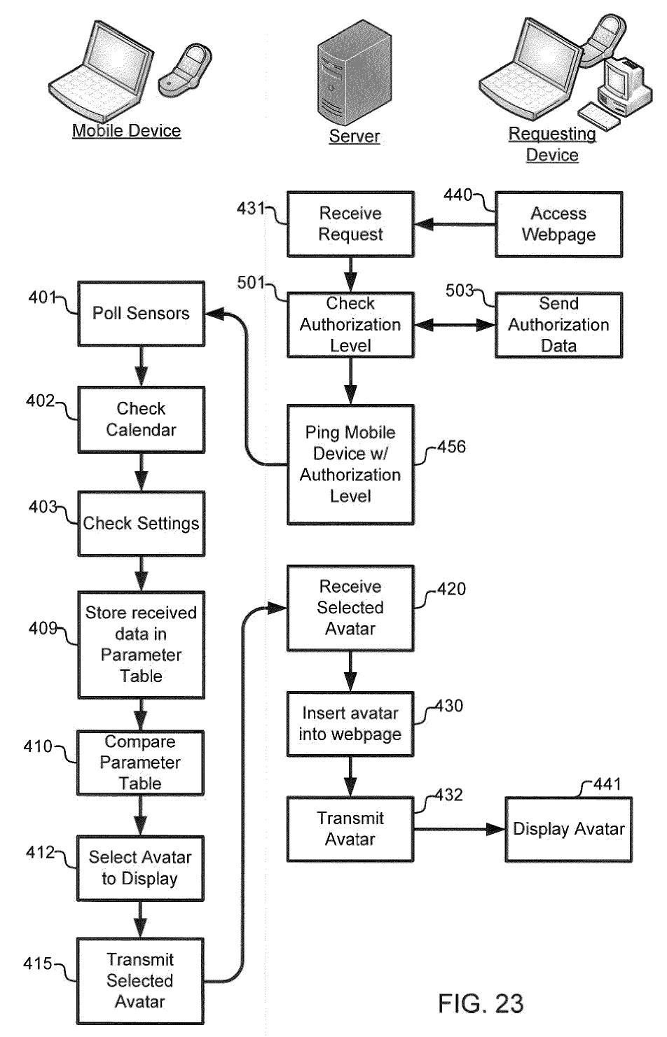

FIG. 23 is a process flow diagram of another embodiment which conserves processing power of the mobile device 301 by only polling sensors, checking device settings and selecting an avatar for display when the server 109 receives a request for the user's avatar. The embodiment shown in FIG. 23 operates much in the same manner as the embodiment illustrated in FIG. 9 with the addition of checking the authorization level of the requester, steps 501, 503, described above with reference to FIGS. 20 and 21. The authorization level determined in steps 501 and 503 is transmitted to the mobile device 301 for storage into the parameter table 602, step 409 as described above with reference to FIG. 5-9. As a result, the avatar may be selected based upon the authorization level of the second user. Once the appropriate avatar has been selected, the avatar can be sent to the requester as described more fully above with reference to FIG. 9 for steps 415-441

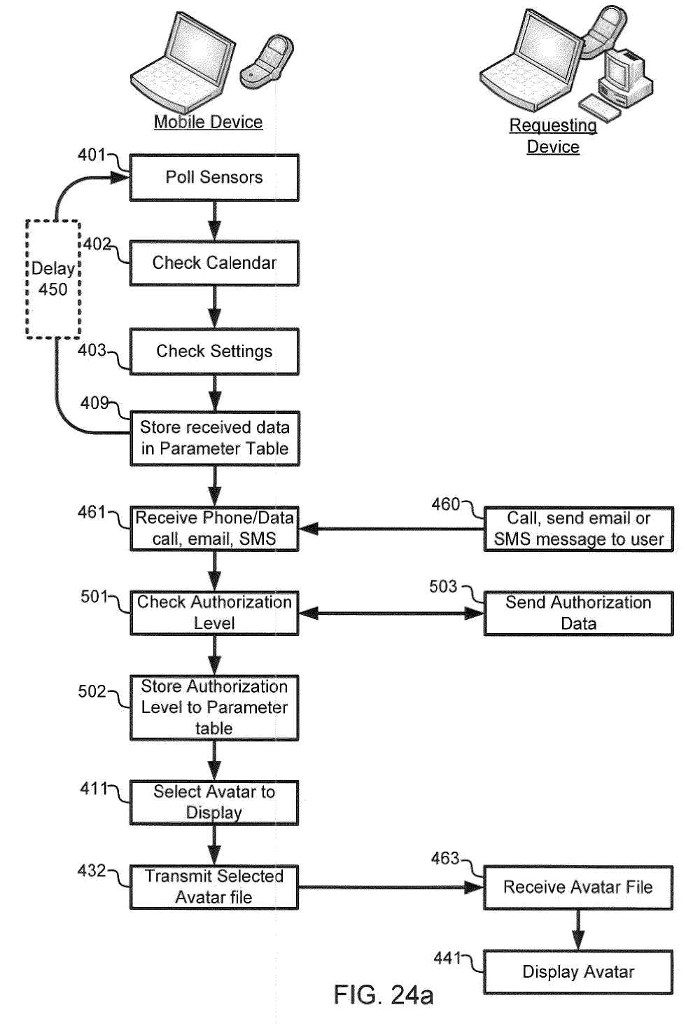

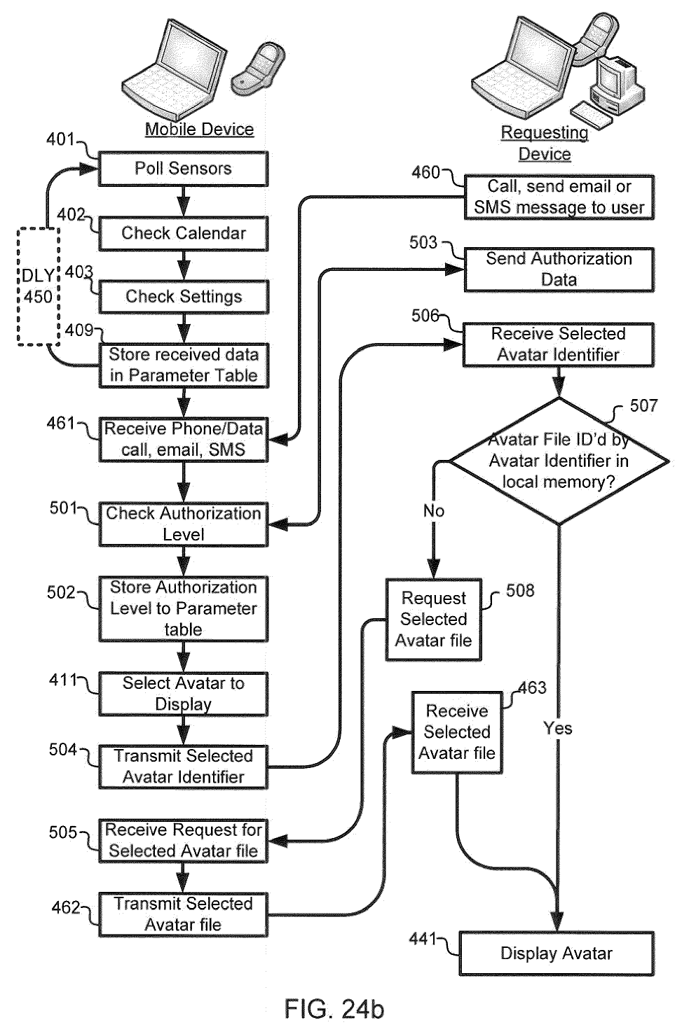

FIG. 24a is a process flow diagram of another embodiment method suitable for displaying an avatar selected based upon sensor and setting data as well as the authorization level of a second user directly on the requesting device. The embodiment illustrated in FIG. 24a operates in the same manner as described above with reference to FIG. 14a with the addition of checking the authorization level of the second user, steps 501 and 503 and storing the authorization level data in the parameter table 602, step 502, described above with reference to FIGS. 20 and 21. Once the authorization level data is stored in the parameter table 602, the complete parameter table 602 can be compared against the avatar selection logic table 603 to select and display the appropriate avatar as described above with reference to FIGS. 14a, 20 and 21 for steps 411, 432, 463, 442.

Alternatively, similar to the embodiments shown in FIGS. 14b, 15b and 16b, the embodiment shown in FIG. 24b modifies the embodiment method shown in FIG. 24a by adding steps 504-508 which transmit only an identifier of the selected avatar file to the second user's device. The local memory of the requesting device is checked to determine whether the transmission of the avatar file is necessary or not. If the avatar file already exists in the local memory of the requesting device, then the avatar file is immediately displayed. If the avatar file does not exist in local memory, then a request for the avatar file is made and subsequently transmitted for display. The alternative embodiment shown in FIG. 24b conserves processing power, battery life and transmission bandwidth and further allows for the use of updated or new avatar files.

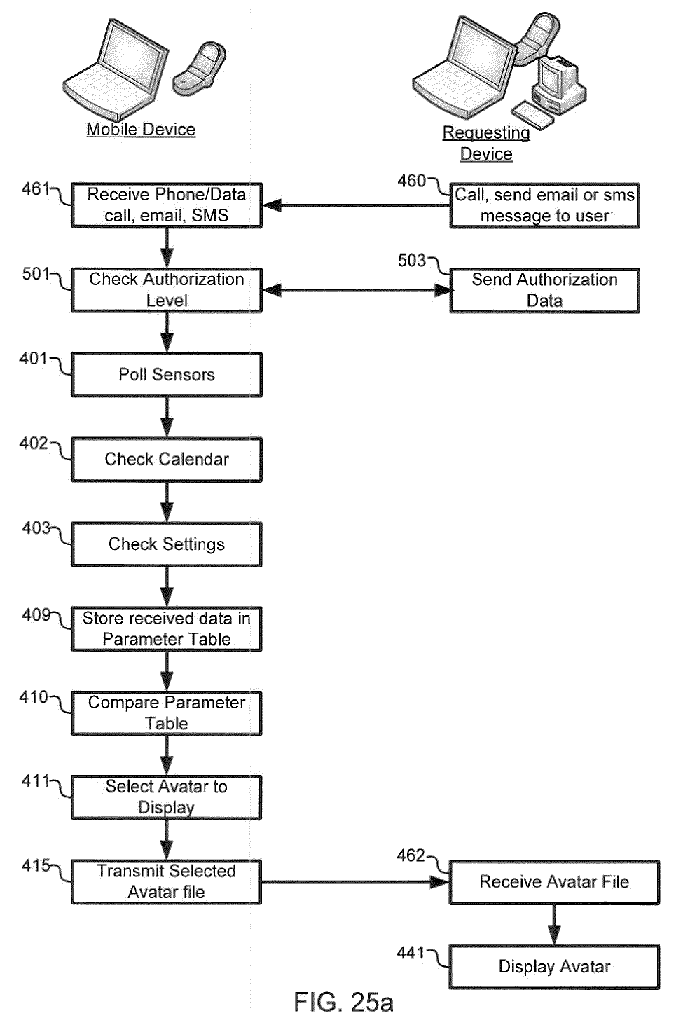

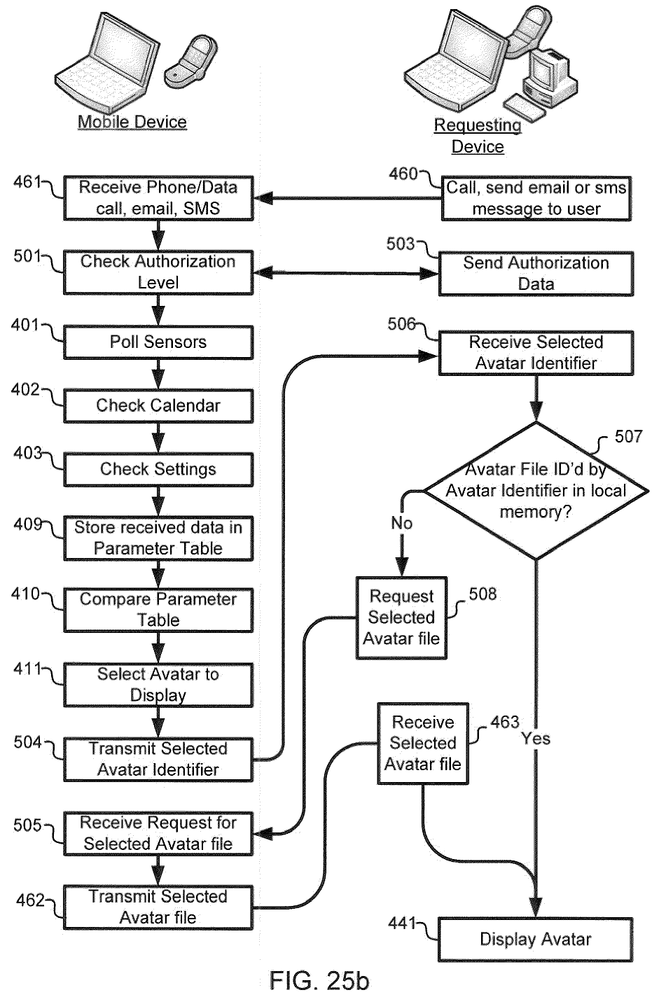

Similar to the embodiment illustrated in FIG. 16a, the embodiment illustrated in FIG. 25a conserves processor and battery time of the mobile device 301 by responding to an avatar request made by a second user. The embodiment illustrated in FIG. 25a operates in the same manner as the embodiment described above with reference to FIG. 16a with the addition of checking and sending the authorization level of the second user, steps 501 and 503 described above with reference to FIGS. 20 and 21. The authorization level data is stored in the parameter table 602 along with the various sensor and settings data, step 409. Once stored, the complete parameter table 602 can be compared against the avatar selection logic table 603, step 410, to select the appropriate avatar to display, step 411. Once selected, the processor 391 then transmits the selected avatar file to the requesting computing device, step 415, which receives the avatar file, step 462, and displays the selected avatar, step 441 as described above with reference to FIGS. 14-16.

Again, similar to the embodiments shown in FIGS. 14b, 15b and 16b, the embodiment shown in FIG. 25b modifies the embodiment method shown in FIG. 25a by adding steps 504-508 which transmit only an identifier of the selected avatar file to the second user's device. The local memory of the requesting device is checked to determine whether the transmission of the avatar file is necessary or not. If the avatar file already exists in the local memory of the requesting device, then the avatar file is immediately displayed. If the avatar file does not exist in local memory, then a request for the avatar file is made and subsequently transmitted for display. The alternative embodiment shown in FIG. 25b conserves processing power, battery life and transmission bandwidth and further allows for the use of updated or new avatar files.

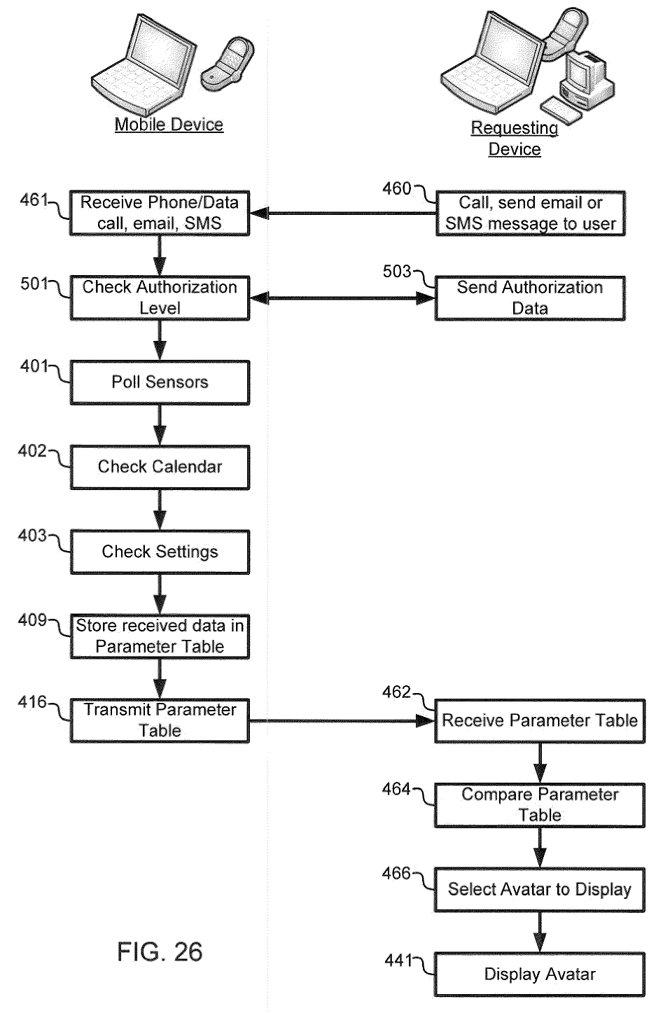

Similar to the embodiment illustrated in FIG. 17, the embodiment illustrated in FIG. 26 pre-stores the avatar files and avatar selection avatar selection logic table 603 on computing devices that are authorized to request the user's avatar. While each of the requesting computing devices are previously authorized to request the user's avatar, some computing devices may be authorized to view only certain avatars in response to various sensor and settings data. The embodiment illustrated in FIG. 26 operates in the same manner as described above with reference to FIG. 17 with the addition of checking and sending the authorization level of the second user, steps 501 and 503, as described above with reference to FIGS. 20 and 21. The authorization level data is stored in the parameter table 602 along with the various sensor and settings data, step 409. Once stored, the complete parameter table 602 can be transmitted to the second user's requesting computing device, step 416, and compared against the avatar selection logic table 603 to select and display the appropriate avatar as described above with reference to FIG. 17 for steps 462, 464, 466, 441.

In an embodiment, artificial intelligence routines may be implemented on the mobile device to prompt users to select an avatar to display when repeated parameter patterns are recognized. For example, if a mobile device continuously polls the GPS sensor 354 and an artificial intelligence application notices that the device is at the same GPS location coordinates between 9 am and 5 pm during weekdays, the processor may prompt the user to identify the name of the location, and suggest a name of “Work”. Alternatively, if the processor 391 notices that the user's pulse detected by a pulse sensor (not shown) has risen above 100 beats per minute, the processor 391 may prompt the user to identify the user's current activity as “exercise.” At the same time, if the processor 391 recognizes from the GPS sensor that the mobile device 301 is moving at a speed greater than 3 miles per hour, the processor 391 may prompt the user to identify the user's current activity as “Running.”

In embodiments where the number of avatar files stored in memory is limited, such as when the avatar files are stored directly on the computing device that will display them, fewer and more generic avatars may be desired. In such instances, fewer parameters may be needed to accurately reflect a user's current status. Conversely, if avatar files are stored on a computing device with greater storage and processing capabilities, such as server 109, the number of avatar files may be increased, as well as the level of precision in matching an avatar with the user's current status.

In further embodiments, parameter data may cause an avatar to change consistent with changes in the user's activity. By refining the avatar selection table 601, 603, varying avatars may be displayed in response to changes in parameter data. For example, if a user is running as inferred by the GPS sensor 354 measuring a velocity of about 6 miles per hour and an accelerometer 353 indicating a periodicity of accelerations consistent with running, the avatar selected for display may be an animated image of a runner. As the GPS sensor 354 records increased, the avatar selected for display may show the running image moving faster, and/or showing the increased effort by displaying an avatar that is running, sweating and breathing harder. To include such additional avatars, including animated avatars, simply requires including another line in the avatar selection logic table 601, 603 linking the increased speed as a requirement to display a new avatar file.

By implementing the various methods disclosed herein, a first user can provide a second user with an accurate representation of the first user's current activity. For example, in an internet forum setting, the displayed avatars could dynamically change as the user changes status. In conventional usage, a user may pro-actively change his/her avatar that is displayed to other members of the internet forum. However, the avatar will only change if the user proactively changes the file selected for display. In the embodiments disclosed herein, other members of the internet forum may observe the user's avatar change automatically as the user changes activity or status. In this way, the user no longer has to actively alter the avatar to be displayed in order to reflect his or her status. One of ordinary skill in the art would appreciate that similar applications can be implemented in instant messaging, text messaging, or even regular phone call situations.

The various embodiments provide a number of new applications for mobile devices. Such applications include improving communications with colleagues, monitoring activities of children, broadening participation in games, and medical monitoring.

As mentioned above, an avatar can quickly communicate information regarding a user since “a picture is worth a thousand words.” Users may select avatars and program the avatar selection criteria so that colleagues can quickly determine their status prior to sending an e-mail or making a telephone call. For example, if a colleague has access to a user's avatar, a quick view of the avatar prior to sending an e-mail or placing a telephone call will inform the colleague whether the user is involved in some activity that will preclude a prompt reply, such as out for a run, in a meeting, or on vacation. Access links to avatars (e.g., a hyperlink to an IP address hosting the avatar) may be incorporated into address books so that if an individual has been given access rights to a user's avatar the individual can check on the user's status prior to or as part of sending an e-mail or placing a telephone call. In this manner, the user of an avatar can proactively inform selected colleagues of the user's status. For example, by posting an avatar showing the user is in a meeting (or on travel or vacation), those who may want to contact the user will be informed that a call will not be answered and e-mail may not be promptly read.

In an application of the various embodiments, parents may be able to keep track of children when they are out of their sight. For example, children wearing a mobile device configured according to one or more of the embodiments can be tracked by parents accessing a website that displays avatars of their children including their location and present activity. For example, children involved in a game of “hide ‘n’ seek” may be monitored by their parents viewing a map of the play area which includes avatars indicating the location and movement/status of each child.

In game settings, the displayed avatar may be more closely linked to the movements and activities of the user's real world movements and activities. For example, the various embodiments may enable a user to be involved in a game of paintball while spectators watch the paintball match in a virtual world representation. Each participant can be equipped with a mobile device 301 including a suite of motion, position and location sensors, each reporting sensor data in near-real time to a central server 109. Additionally, position sensors may be outfitted on users' limbs and coupled to the mobile device by a wireless data link (e.g., Bluetooth) to provide data on the posture and movements of participants, such as the direction in which an individual is facing or aiming a paintball gun. An avatar representing each paintball participant can be generated in the virtual world representation of the match, with each user's avatar changing location and activity (i.e., running, sitting, hiding) based on the mobile device 301 sensor data which are sampled in real time. The virtual world avatar representations may therefore, accurately mimic the movement and activity of the real world users carrying the mobile devices 301.

Clearly, the same settings that apply to games could be transferred to training exercises of a national defense nature.

In a medical monitoring application, medical sensors on the mobile device 301 or connected to a processor by wireless data links (e.g., Bluetooth) can report their data (e.g., through the mobile device 301) to a system that uses such information to select an avatar that reflects the patient's current status. In a medical setting, the processor need not be mobile, and instead may be associated with a facility, such as an emergency room or hospital information system. Sensor data associated with patients can be received from a variety of medical sensors coupled to each patient, such as blood pressure, pulse, EKG, and EEG sensors for example. Avatar selection criteria associated with each of the sensors may be used to select an avatar that reflects a patient's medical needs or condition. For example, if a medical sensor provides data that satisfies an avatar criteria for a patient in distress, a processor can select an avatar consisting of the patient's photograph with a red background, and display that avatar on a nursing station. The use of such an avatar can more efficiently communicate critical information than text (e.g., the patient's name and the medical data) presented on the screen. As another example, a pacemaker may be configured to transmit information regarding the condition of the device or the patient's heart to a mobile device, such as by means of a Near Field Communications data link, which can relay the data to a server accessible by the patient's doctor. That server can use the patient's pacemaker data to select an appropriate avatar to efficiently communicate the patient's status to the doctor.

The hardware used to implement the foregoing embodiments may be processing elements and memory elements configured to execute a set of instructions, wherein the set of instructions are for performing method steps corresponding to the above methods. Alternatively, some steps or methods may be performed by circuitry that is specific to a given function.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile handset are intended to encompass any one or all memory modules within the mobile handset without limitation to a particular configuration, type or packaging. An exemplary storage medium is coupled to a processor in either the mobile handset or the theme server such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A method for automatically updating an avatar to indicate a mobile device user's status, comprising:
polling sensors connected to the user's mobile device;
comparing sensor data to avatar selection criteria; and
selecting an avatar for display based upon the comparison of the sensor data to the avatar selection criteria.

2. The method of claim 1, further comprising:
comparing calendar data to avatar selection criteria; and
selecting the avatar for display further based upon the comparison of calendar data with avatar selection criteria.

3. The method of claim 1, further comprising:
comparing mobile device settings to avatar selection criteria; and
selecting the avatar for display further based upon the comparison of mobile device settings with avatar selection criteria.

4. The method of claim 1, further comprising:
comparing an authorization level of a second user to avatar selection criteria; and
selecting the avatar for display further based upon the comparison of the authorization level of the second user with avatar selection criteria.

5. The method of claim 1, wherein the steps of polling sensors, comparing sensor data to avatar selection criteria and selecting an avatar for display are performed in response to a request for an avatar received from a server.

6. The method of claim 1, wherein the steps of polling sensors, comparing sensor data to avatar selection criteria and selecting an avatar for display are performed in response to a request for an avatar received from another computing device, and further comprising transmitting the selected avatar to the other computing device for display.

7. The method of claim 5, wherein the server requests an avatar from the mobile device only when a request for the avatar is received by the server.

8. The method of claim 1, further comprising:
transmitting an identifier of the selected avatar to a server; and
recalling an avatar file from the server's memory using the identifier.

9. The method of claim 1, further comprising transmitting the sensor data to a server, wherein the steps of comparing the sensor data to avatar selection criteria and selecting an avatar for display based upon the comparison are performed on the server.

10. The method of claim 9, further comprising inserting the selected avatar into a webpage hosted by the server.

11. The method of claim 9, further comprising:
transmitting calendar data to the server;
comparing calendar data to avatar selection criteria at the server; and
selecting the avatar for display further based upon the comparison of calendar data with avatar selection criteria performed at the server.

12. The method of claim 9, further comprising:
transmitting mobile device settings to the server;
comparing mobile device settings to avatar selection criteria at the server; and
selecting the avatar for display further based upon the comparison of mobile device settings with avatar selection criteria performed at the server.

13. The method of claim 1, further comprising transmitting the sensor data to another computing device, wherein the steps of comparing the sensor data to avatar selection criteria and selecting an avatar for display based upon the comparison are performed on the other computing device.

14. The method of claim 13, further comprising:
transmitting calendar data to the other computing device;
comparing calendar data to avatar selection criteria at the other computing device; and
selecting the avatar for display further based upon the comparison of calendar data with avatar selection criteria performed at the other computing device.

15. The method of claim 13, further comprising:
transmitting mobile device settings to the other computing device;
comparing mobile device settings to avatar selection criteria at the other computing device; and
selecting the avatar for display further based upon the comparison of mobile device settings with avatar selection criteria performed at the other computing device.

16. The method of claim 13, further comprising;
obtaining an authorization level of the other computing device;
comparing the authorization level of the other computing device to avatar selection criteria at the other computing device; and
selecting the avatar for display further based upon the comparison of the authorization level of the other computing device with avatar selection criteria performed at the other computing device.

17. The method of claim 1, wherein the step of polling sensors connected to the user's mobile device comprises obtaining data from at least one sensor selected from the group consisting of a global positioning sensor, an accelerometer, a temperature sensor, a biometric sensor, a light sensor, and a noise sensor.

18. A mobile device, comprising:
a processor;
a transceiver coupled to the processor;
a memory coupled to the processor; and
at least one sensor configured to measure a selected parameter from the group consisting of a global positioning sensor, an accelerometer, a temperature sensor, a biometric sensor, a light sensor, and a noise sensor, wherein the processor is configured with software instructions to perform steps comprising:
receiving sensor data from the at least one sensor;
comparing the sensor data to avatar selection criteria; and
selecting an avatar for display based upon the comparison of the sensor data to the avatar selection criteria.

19. The mobile device of claim 18, wherein processor is configured with software instructions to perform steps further comprising:
comparing calendar to avatar selection criteria; and
selecting the avatar for display further based upon the comparison of calendar data with avatar selection criteria.

20. The mobile device of claim 18, wherein processor is configured with software instructions to perform steps further comprising:
comparing mobile device settings to avatar selection criteria; and
selecting the avatar for display further based upon the comparison of mobile device settings with avatar selection criteria.

21. The mobile device of claim 18, wherein processor is configured with software instructions to perform steps further comprising:
comparing an authorization level of a second user to avatar selection criteria; and
selecting the avatar for display further based upon the comparison of the authorization level of the second user with avatar selection criteria.

22. The mobile device of claim 18, wherein the processor is configured with software instructions to perform the steps of receiving sensor data, comparing sensor data to avatar selection criteria and selecting an avatar for display in response to a request for an avatar received from a server.

23. The mobile device of claim 18 wherein processor is configured with software instructions to perform the steps of receiving sensor data, comparing sensor data to avatar selection criteria and selecting an avatar for display in response to a request for an avatar received from another computing device.

24. The mobile device of claim 22, wherein processor is configured with software instructions to perform steps further comprising transmitting an identifier of the selected avatar to the server via the transceiver.

25. The mobile device of claim 22, wherein processor is configured with software instructions to perform steps further comprising transmitting the selected avatar to the server via the transceiver.

26. The mobile device of claim 23, wherein processor is configured with software instructions to perform steps further comprising transmitting the selected avatar to the other computing device via the transceiver.

27. The mobile device of claim 18, further comprising a short range wireless transceiver configured to receive sensor data from an external sensor and provide the sensor data to the processor.

28. A mobile device, comprising:
means for sensing a parameter indicative of a user's status;
means for comparing the sensed parameter to avatar selection criteria; and
means for selecting an avatar for display based upon the comparison.

29. The mobile device of claim 28, further comprising:
means for comparing mobile device settings to avatar selection criteria; and
means for selecting the avatar for display further based upon the comparison of mobile device settings with avatar selection criteria.

30. The mobile device of claim 28, further comprising:
means for comparing mobile device settings to avatar selection criteria; and
means for selecting the avatar for display further based upon the comparison of mobile device settings with avatar selection criteria.

31. The mobile device of claim 28, further comprising:
means for comparing an authorization level of a second user to avatar selection criteria; and
means for selecting the avatar for display further based upon the comparison of the authorization level of the second user with avatar selection criteria.

32. The mobile device of claim 28, further comprising means for transmitting the selected avatar to a server.

33. The mobile device of claim 28, further comprising means for receiving sensor data from a sensor external to the mobile device.

34. A tangible storage medium having stored thereon processor-executable software instructions configured to cause a processor to perform steps comprising:
receiving sensor data from at least one sensor coupled to the processor;
comparing the sensor data to avatar selection criteria; and
selecting an avatar for display based upon the comparison of the sensor data to the avatar selection criteria.

35. The tangible storage medium of claim 34, wherein the tangible storage medium has processor-executable software instructions configured to cause a processor to perform further steps comprising:
comparing calendar to avatar selection criteria; and
selecting the avatar for display further based upon the comparison of calendar data with avatar selection criteria

36. The tangible storage medium of claim 34, wherein the tangible storage medium has processor-executable software instructions configured to cause a processor to perform further steps comprising:
comparing mobile device settings to avatar selection criteria; and
selecting the avatar for display further based upon the comparison of mobile device settings with avatar selection criteria.

37. The tangible storage medium of claim 34, wherein the tangible storage medium has processor-executable software instructions configured to cause a processor to perform further steps comprising:
comparing an authorization level of a second user to avatar selection criteria; and
selecting the avatar for display further based upon the comparison of the authorization level of the second user with avatar selection criteria.

38. The tangible storage medium of claim 34, wherein the tangible storage medium has processor-executable software instructions configured to cause a processor to the perform steps of receiving sensor data, comparing sensor data to avatar selection criteria and selecting an avatar for display in response to a request for an avatar received from a server.

39. The tangible storage medium of claim 34, wherein the tangible storage medium has processor-executable software instructions configured to cause a processor to the perform steps of receiving sensor data, comparing sensor data to avatar selection criteria and selecting an avatar for display in response to a request for an avatar received from another computing device.

40. The tangible storage medium of claim 34, wherein the tangible storage medium has processor-executable software instructions configured to cause a processor to perform further steps comprising transmitting an identifier of the selected avatar to a server.

41. The tangible storage medium of claim 34, wherein the tangible storage medium has processor-executable software instructions configured to cause a processor to perform further steps comprising transmitting the selected avatar to a server.

42. A server configured to host a user's social webpage and receive and transmit data via a network, comprising:
a server memory having stored thereon the user's social webpage; and
a server processor coupled to the server memory, wherein the server processor is configured with software instructions to perform steps comprising:
receiving sensor data from the user's mobile device;
comparing the received sensor data to avatar selection criteria;
selecting an avatar for display based upon the comparison of the sensor data with avatar selection criteria; and
including the selected avatar into the user's social webpage stored in the server memory.

43. The server of claim 42, wherein the server processor is further configured with software instructions to perform steps comprising:
receiving calendar data from the user's mobile device;
comparing the calendar data to avatar selection criteria; and
selecting the avatar for display further based upon the comparison of the calendar data with avatar selection criteria.

44. The server of claim 42, wherein the server processor is further configured with software instructions to perform steps comprising:
receiving mobile device settings from the user's mobile device;
comparing the mobile device settings to avatar selection criteria; and
selecting the avatar for display further based upon the comparison of the mobile device settings with avatar selection criteria.

45. The server of claim 42, wherein the server processor is further configured with software instructions to perform steps comprising:
receiving authorization level data from a second user's computing device;
comparing the authorization level data of the second user's computing device to avatar selection criteria; and
selecting the avatar for display further based upon the comparison of the authorization level of the second user's computing device with avatar selection criteria.

46. The server of claim 42, wherein the server processor is further configured with software instructions to perform steps comprising:
receiving a parameter value table from the user's mobile device;
comparing values in the parameter value table to avatar selection criteria; and
selecting the avatar for display further based upon the comparison of the parameter value table with avatar selection criteria.

47. The server of claim 42, wherein the server processor is further configured with software instructions to perform steps comprising:
requesting the user's mobile device to transmit sensor data.

48. The server of claim 42, wherein the server processor is further configured with software instructions to perform steps comprising requesting the user's mobile device to transmit sensor data in response to receiving a request for the user's avatar.

49. A server, comprising:
means for receiving sensor data from the user's mobile device;
means for comparing the received sensor data to avatar selection criteria;
means for selecting an avatar for display based upon the comparison of the sensor data with avatar selection criteria; and
means for including the selected avatar into the user's social webpage stored in the server memory.

50. The server of claim 49, further comprising:
means for receiving calendar data from the user's mobile device;
means for comparing the calendar data to avatar selection criteria; and
means for selecting the avatar for display further based upon the comparison of the calendar data with avatar selection criteria.

51. The server of claim 49, further comprising:
means for receiving mobile device settings from the user's mobile device;
means for comparing the mobile device settings to avatar selection criteria; and
means for selecting the avatar for display further based upon the comparison of the mobile device settings with avatar selection criteria.

52. The server of claim 49, further comprising:
means for receiving authorization level data from a requesting user's computing device;
means for comparing the authorization level data of the requesting user's computing device to avatar selection criteria; and
means for selecting the avatar for display further based upon the comparison of the authorization level of the requesting user's computing device with avatar selection criteria.

53. The server of claim 49, further comprising means for receiving a parameter value table from the user's mobile device;
means for comparing values in the parameter value table to avatar selection criteria; and
means for selecting the avatar for display further based upon the comparison of the parameter value table with avatar selection criteria.

54. The server of claim 49, further comprising means for requesting the user's mobile device to transmit sensor data.

55. The server of claim 49, further comprising means for requesting the user's mobile device to transmit sensor data in response to receiving a request for the user's avatar.

56. A tangible storage medium having stored thereon server-executable software instructions configured to cause the server to perform steps comprising:
receiving sensor data from the user's mobile device;
comparing the received sensor data to avatar selection criteria;
selecting an avatar for display based upon the comparison of the sensor data with avatar selection criteria; and
including the selected avatar into the user's social webpage stored in the server memory.

57. The tangible storage medium of claim 56, wherein the stored server-executable software instructions are configured to cause the server to perform further steps comprising:
receiving calendar data from the user's mobile device;
comparing the calendar data to avatar selection criteria; and
selecting the avatar for display further based upon the comparison of the calendar data with avatar selection criteria.

58. The tangible storage medium of claim 56, wherein the stored server-executable software instructions are configured to cause the server to perform further steps comprising:
receiving mobile device settings from the user's mobile device;
comparing the mobile device settings to avatar selection criteria; and
selecting the avatar for display further based upon the comparison of the mobile device settings with avatar selection criteria.

59. The tangible storage medium of claim 56, wherein the stored server-executable software instructions are configured to cause the server to perform further steps comprising:
receiving authorization level data from a requesting user's computing device;
comparing the authorization level data of the requesting user's computing device to avatar selection criteria; and
selecting the avatar for display further based upon the comparison of the authorization level of the requesting user's computing device with avatar selection criteria.

60. The tangible storage medium of claim 56, wherein the stored server-executable software instructions are configured to cause the server to perform further steps comprising:
receiving a parameter value table from the user's mobile device;
comparing values in the parameter value table to avatar selection criteria; and
selecting the avatar for display further based upon the comparison of the parameter value table with avatar selection criteria.

61. The tangible storage medium of claim 56, wherein the stored server-executable software instructions are configured to cause the server to perform further steps comprising requesting the user's mobile device to transmit sensor data.

62. The tangible storage medium of claim 56, wherein the stored server-executable software instructions are configured to cause the server to perform further steps comprising requesting the user's mobile device to transmit sensor data in response to receiving a request for the user's avatar.
